(19) United States
(12) Patent Application Publication
(10) Pub. No.: US 2014/0132633 A1
(43) Pub. Date: May 15, 2014

(54) ROOM DESIGN SYSTEM WITH SOCIAL MEDIA INTERACTION

(71) Applicants: VICTORIA FEKETE, TORONTO (CA); MELVYN LOA WING FAT, TORONTO (CA); THIERRY LOA, TORONTO (CA)

(72) Inventors: VICTORIA FEKETE, TORONTO (CA); MELVYN LOA WING FAT, TORONTO (CA); THIERRY LOA, TORONTO (CA)

(21) Appl. No.: 14/159,273

(22) Filed: Jan. 20, 2014

Related U.S. Application Data
(63) Continuation-in-part of application No. PCT/CA2011/000826, filed on Jul. 20, 2011.
(60) Provisional application No. 61/762,561, filed on Feb. 8, 2013.

(51) Int. Cl. G06T 11/60

(52) U.S. Cl. CPC G06T 11/60
USPC 345/634

(57) ABSTRACT

The present specification provides a novel social network platform for creating, using and sharing online spaces populated with their furnishings. In certain implementations, the first web page is a sign-in page or a sign-up to create an account. Upon account creation, a basic empty 3-D room can be generated. Three views of the same room can be available, windowed (small & large), and full screen, all of which can be toggled between at any time using standard screen sizing icons. In some embodiments a room can consist of a back wall, a perspective wall on either side of the back wall, and a floor.

### CROSS-REFERENCE TO RELATED APPLICATIONS

This application claims the benefit of PCT Patent Application No. PCT/CA2011/000826 filed on Jul. 20, 2011 and U.S. Provisional Patent Application No. 61/762,561 filed on Feb. 8, 2013, and incorporates the subject matter of said applications by reference.

### FIELD

The present specification relates generally to computing devices and more specifically relates to a system for a social media platform configured for interconnecting with a plurality of disparate content servers.

### BACKGROUND

Social media has emerged as a core communication technology. However, it is still in its infancy and there are many current technical limitations.

Consumers are interested in exploring designs of a physical environment to include physical objects, including possibly in advance of purchasing items. This can be advantageous in particular in relation to more expensive items such as furniture, artwork, electronics, lighting, wall coverings, window coverings, and floor coverings (collectively referred to in this disclosure as “design items”). Exploring designs involving different combinations of such items can be impractical in a physical environment. There is a need for a digital environment that allows consumers to explore different design options freely.

Consumers connected to social media networks want to generate new content, and also are interested in engaging in social media interactions with other members of their social networks, including to share design ideas with their social networks, and share digital content based on their design ideas with others.

Brands, for example manufacturers or sellers of design items, need access to reliable information regarding the interests of their customers and potential customers.

There is a need for a digital media and social media platform that addresses these and other related requirements.

### BRIEF DESCRIPTION OF THE DRAWINGS

FIG. 1 is a schematic representation of a system for a social media platform configured for interconnecting with a plurality of disparate content servers.

FIG. 2 is a flow chart depicting a method for data record management and processing.

FIG. 3 is an example screen that can be generated on a client machine in the system of FIG. 1 according to performance of the method in FIG. 2.

FIG. 4 is an example of contents of a furnishings database that can be used with the method of FIG. 2 and the system of FIG. 1.

FIG. 5 is an example of contents of a furnishings database that can be used with the method of FIG. 2 and the system of FIG. 1.

FIG. 6 is an example of contents of a furnishings database that can be used with the method of FIG. 2 and the system of FIG. 1.

FIG. 7 is an example of contents of a furnishings database that can be used with the method of FIG. 2 and the system of FIG. 1.

FIG. 8 is an example of contents of a furnishings database that can be used with the method of FIG. 2 and the system of FIG. 1.

FIG. 9 is an example set of image renderings that can be associated with furnishing 108-7 of FIG. 6.

FIG. 9 is an example of the room shown in FIG. 3 with various wall furnishings.

FIG. 10 is an example of the virtual room shown in FIG. 3 with various available furnishings in a tool bar area.

FIG. 11 is an example of the virtual room shown in FIG. 3 with various available furnishings in a tool bar area.

FIG. 12 is an example of certain available furnishings from the tool bar area of FIG. 11 having been placed within the virtual room shown in FIG. 11.

FIG. 13 is an example of one of the furnishings from FIG. 11 having been moved and rotated to a different location than the location and rotation shown in FIG. 12.

FIG. 14 shows the virtual room of FIG. 11 with further examples of interactions that can be implemented therewith.

FIG. 15 shows the virtual room of FIG. 11 with further examples of interactions that can be implemented therewith.

FIG. 16 shows a non-limiting example of how a furnishing can be imported from a content server to the central database engine of FIG. 1.

FIG. 17 shows the virtual room of FIG. 11 with further examples of interactions that can be implemented therewith.

### DETAILED DESCRIPTION OF THE EMBODIMENTS

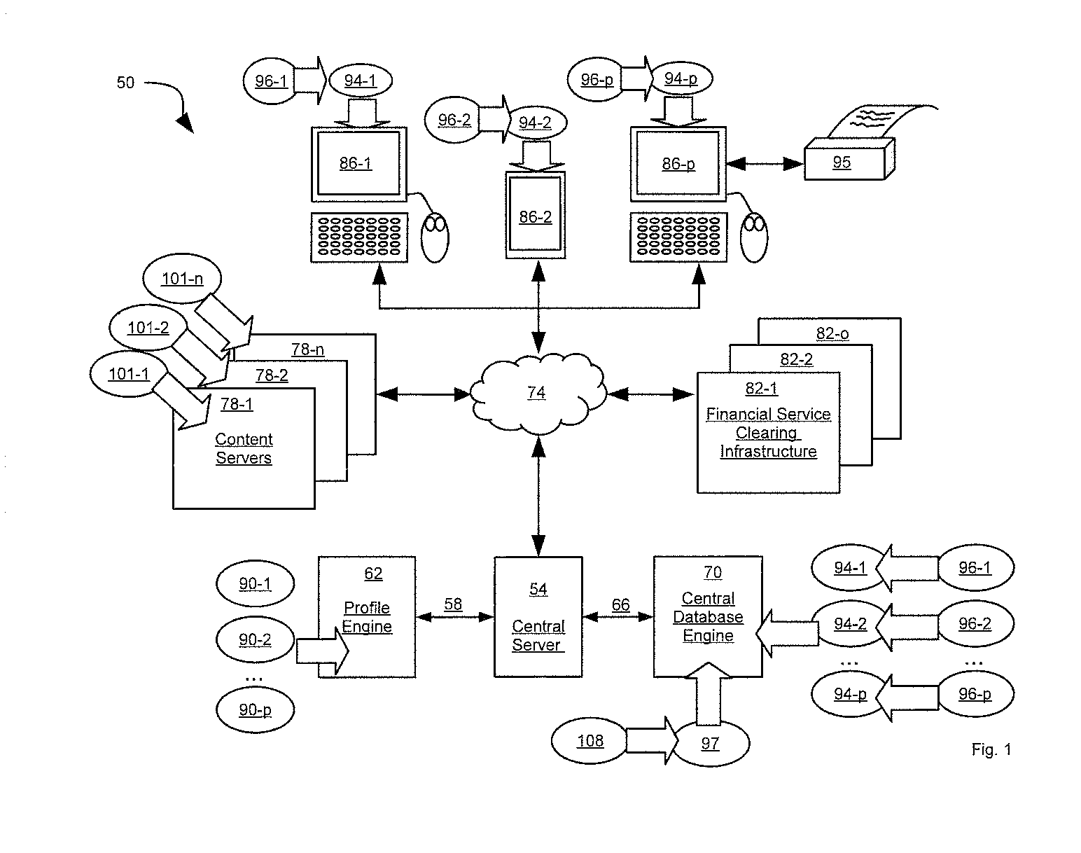

FIG. 1 a schematic representation of one possible computer network implementation of the present invention. A skilled reader will understand that many different computer network implementations are possible, and the particular embodiments described in this disclosure are intended to aid in the understanding of the invention and possible ways in which it may be implemented.

In one aspect of the invention, a computer networking environment is provided that allows one or more users to compose a virtual physical environment by (a) selecting one or more attributes related to a virtual physical environment (such as for example one or more attributes for a virtual “room”), and (b) iteratively selecting one or more digital models each representing a design item (referred to as “design objects” in this disclosure, and placing and arranging the design objects in the virtual physical environment.

The computer networking environment may be defined by a computer system that makes available to users a 3D interactive web application for composing virtual physical environments, interacting with these virtual physical environments, and engaging in social media interactions with others in regards to the virtual physical environments. The computer system may consist of one or more computers, a server computer or a server farm. The web application may be made part of an application repository. The computer system may incorporate or be linked to a social media environment that defines a social media network that enables the social media interactions described in this disclosure. The social media environment may linked to the computer network environment of the present invention, or the computer network environment may include a social media environment. The computer network environment of the invention may be referred to as the “platform”.

A skilled reader will understand that both the computer network environment of the present invention and the social media environment referred to, may be implemented in a variety of ways that will be suitable for enabling the novel and innovative functions, features, and workflows described in this disclosure. To illustrate the operation of the present invention, the present disclosure discusses various possible computer system embodiments of the present invention. The invention is not limited to a particular computer system embodiment.

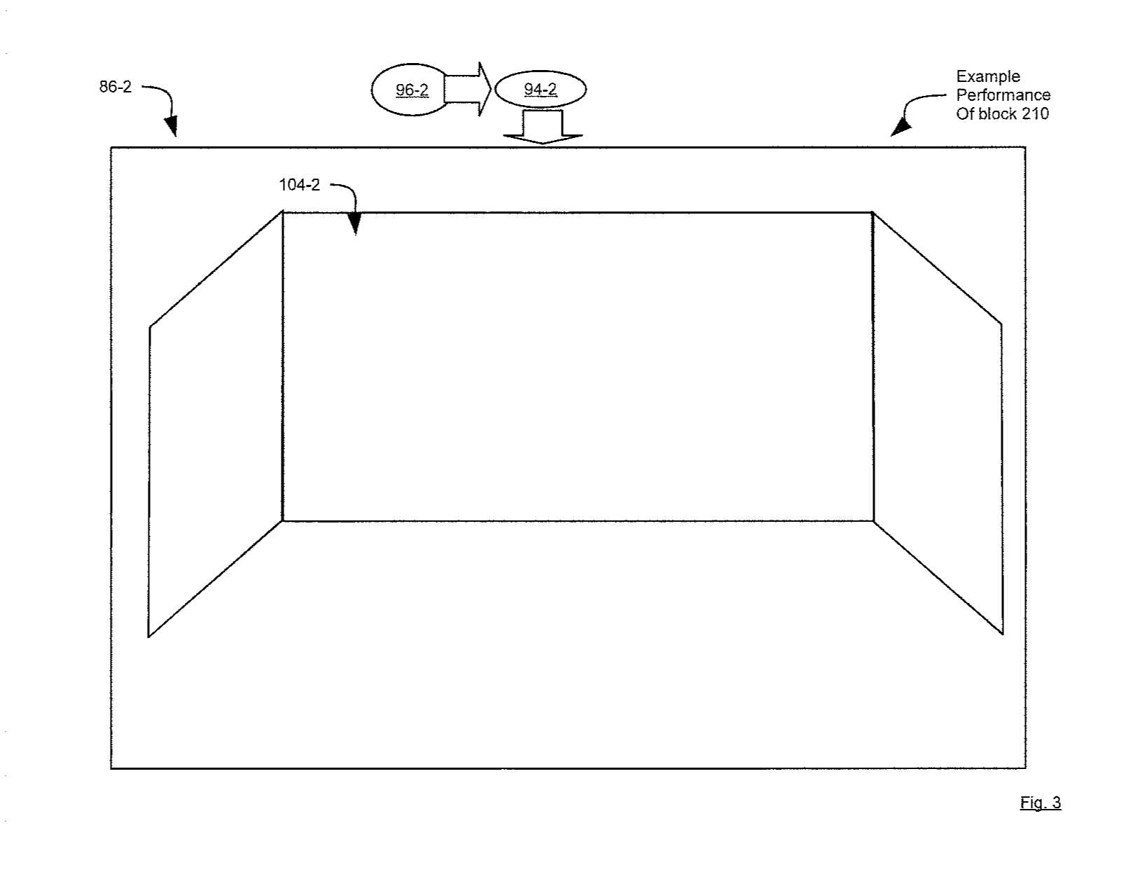

The room may consist of a three-dimensional (“3D”) representation of an elevated side view into a room, such as shown in FIG. 3. This view may show for example a floor, a back wall and two side walls. There may be a plurality of room types to select from for example a “living room”, “family room”, “bedroom”, “kitchen”, “bathroom”, and so on. Other variations are possible.

The design items may consist of, for example, furniture, artwork, electronics, lighting, wall coverings, window coverings, and floor coverings. Other items are possible.

The design objects may be created as photorealistic 3D objects. In one important insight of the present invention, the design objects have been pre-rendered such that they can be placed into and arranged in the virtual physical environment in such a way that they present on a computer display in a way that simulates how the physical object design item would appear in a physical room corresponding to the virtual physical environment.

More specifically, rather than using a vector based approach, the platform uses a raster based approach in which in one implementation all asset files (corresponding to design items) are pre-rendered in every possible position (or possible based on likely design choices) thereby enabling real-time movement and increased fidelity of the user experience. In one aspect, a grid system is used and where applicable (depending on the design item) the design item is rendered for every square on the grid in 45° or 90° increments allowing for rotation on each square. Rendering each item several times for each square allows the platform to achieve perspective in connection with real time manipulation of the design objects such that design objects become smaller towards the back of the room. Exceptions may occur for example for wall mounted objects where the perspective is achieved through code increasing and decreasing size of asset as it nears the front and moves to the back of the space.

For example: The design items are rendered to the scale of the room. The room entity is defined based on a series of rules that define how design objects digital models may be placed in the room and how they will behave as the user moves them around or otherwise arranges them within the room. In one aspect, rooms are configured in the platform, and so are design objects, using known parametric design principles. In other words, rooms and design objects that may be placed in them, incorporate rules that defines the relationships between these elements, i.e. between rooms and design objects, and between design objects and other design objects placed in the same room (referred to as “parametric space attributes”). This allows the room and the associated design objects to be placed and arranged by users in a way that cumulatively simulates the behaviour of corresponding physical objects in a corresponding physical space. It also allows changes to percolate through the different design elements of a room whenever a change is made. For example, a design object of a floor covering embodies rules defining that the floor covering (such as a rug) will appear flat on the floor of the room; where on the floor a rug may be placed; the fact that furniture may be placed so that it appears to be on top of the rug, and so on.

In one possible implementation of the present invention, the design objects are rendered as digital images with 3D attributes consisting of bitmap objects where position and rotation of the object in the space rendered individually as opposed to vector files rendered that define a collective view that must be rendered in real-time.

Also, in one implementation PNG files are used with alpha transparency channels, in order to reduced the file size. This allows objects to be moved in real time without losing visual clarity, while keeping scale intact.

The platform may include a web presentment utility that when executed presents a series of web pages that include the functions and features described in this invention. In one aspect of a platform, an administration utility allows an administrator to define the requirements for users to register to the platform, and optionally different functions and features accessible to users, or groups of users. The platform includes or links to a database, which may include a library of the rendered design objects (“object library”). In one implementation, each design object is associated with a unique identifier. A product profile library in which a profile may be created, managed, and updated for each product represented by the design objects. The profile may contain up to date information regarding the products and related information. The product profile library is configured to be updated regularly, and may be linked to remote computer systems for receiving and logging such updates. For example, a manufacturer or distributor of a product represented by a design object may be provided with limited access to the product profile library to submit updated information. This information may be reviewed by an administrator prior to being launched to the platform.

The web presentment utility makes accessible to each registered user a series of web pages that may be generally defined by: (A) a landing page for the user; (B) the landing page allows the user to (i) manage their profile, (ii) access rooms that may have been created previously, (iii) edit rooms, (iv) view their “collection” (explained further below), and (v) engage in social media interactions with others related to their rooms and their content (also as explained below).

The administration utility also allows users to provide information regarding themselves to build their user profile, using a user profile manager. The user profile manager receives information from the user and also may be configured to find and log other information regarding users to the relevant user profile including based on user's actions through the platform, social media interactions associated with the platform, and information extracted from other networks such a social networks, LinkedIn™, Twitter™ and so on. The user profile manager is linked to the analytics utility of the platform, including to develop insights regarding users, including user interest insights, and log these to relevant user profile. The user profile manager is configured in order to enable the logging of actions, and related insights, for example on a product by product basis or brand by brand basis. The user profile manager and the analytics utility may incorporate or link to various platforms or tools that extend or enhance their key functions which include learning about consumer interest in products or brands and product or brand combinations.

A skilled reader will understand that the platform is designed to provide an engaging computer network environment that meets the needs of consumers to explore design ideas, and especially to do so test ideas prior to committing to purchasing items. A key insight of the present invention is that selection of design items happens in the context of interrelated design choices, such as a lamp that looks good with a particular couch, but this is not generally reflected in the current physical or online retail environments. In other words, consumers are interested in buying items that define together an environment that flows, and feels thought out from a design perspective. Consumers are not interested in buying individual items that do not “fit” with other items required or desired for a particular room. This issue is somewhat addressed by large show rooms, where design items are presented together in different arrangements, but the number of combinations are limited and consumers in fact desire to see their intended combination and arrangement, and possibly not once but several times. Decisions to make these purchases for many consumers are not made quickly, they are made iteratively so that the consumer develops comfort with the various choices involved. This is especially true for larger ticket items. Also, higher end items tend to be bought by consumers with well developed aesthetics, and from multiple vendors or stores. Consumers may try to remember the items that they have in mind; or take photos of them; or obtain catalogues and even prepare collages of items (including electronic scrapbooking tools), but this does not provide a pleasing and engaging experience, and it can be a lot of work.

The result is that consumers often are interested in making purchases but since they are not being given the tools to do so, many possible purchases are not being made. Another implication of prior art solutions is that consumers may make purchase decisions that seemed to them to work well but once arranged in their physical space, the consumer may regret their decision or change their mind. This may result in the consumer living with an item that they do not like, which will negatively affect their impression of the associated brand and therefore the brand's reputation with this consumer. Another implication is that consumers may buy and return items, which is inconvenient for consumers, and also inconvenient for manufacturers/distributors/retailers (collectively referred to as “vendors”). (“Consumers” and “users” may be used inter-changeably. “Registered users” refers to person who have registered to the website associated with the computer system of the present invention.)

Also, it has been shown that consumers will buy larger ticket items if they are given the opportunity “grow to like” the item. Designers address some of these issues in part by advising consumers on design choices that may be more likely to be pleasing to the consumer, or preparing material such as sketches or digital representations that reflect design choice options. These services however can be quite expensive and do not give effect to the desire of many consumers to explore design choices more fully on their own, and significantly, on an iterative basis.

In another aspect, designers can use the platform to demonstrate their vision and share online, even collaborate online in real time through the platform.

Also, consumers are often interested in getting input from friends and family regarding their choices, for example a friend or relative whose design aesthetic the consumer respects or shares. Organizing a time to visit a show room or trying to obtain input on multiple design choices and how these relate to one another can be time consuming and cumbersome.

To this end, the platform includes a series of functions that enable consumers to share choices and content through the platform with others, including their social networks. This allows consumers to consult with other, or obtain input from others, in an efficient manner. Also, content created by the platform provides content that consumers can share through their social networks which fulfils the interest of consumers in platforms that generate content for them to share.

The design of the platform described represents a series of insights and discoveries made by the inventors and provides to consumers an engaging Internet based solution that is accessible from anywhere and easy to use that allows consumers to explore design ideas iteratively so that these progress to design choices and eventually to purchase decision with which the consumer will be happy.

In one aspect of the invention, the operator of the platform works with one or more vendors to incorporate into the platform information regarding design items that is useful to consumers, such as colour options, dimension information, material information, manufacturing information, design tips and so on. Incorporating information that is useful and also possibly insightful presents a first opportunity to create engagement between consumers and brands. Additionally, based on the user profiles and the operation supported by the analytics utility, the platform generates significant insights into consumer trends and consumer preferences. This information may be made available to vendors, for example in the form of electronic reports, or accessed by subscribing to a service or dashboard (“vendor dashboard”) that accesses the relevant information from the platform and presents it to the vendor. A skilled reader will understand that various data visualization or presentation techniques may be used in connection with the platform of the present invention. A skilled reader will also understand that the vendor dashboard may incorporate or be linked to various tools for building consumer insights by leveraging the data sets gathered by the platform. The insights may be used by vendors to develop better targeted campaigns, stock inventory efficiently, optimize distribution networks, or develop products that are more appealing to consumers.

While the inventor contemplates a computer network environment in which consumers can explore design ideas without interruptions caused by being targeted by offers or ads, a skilled reader will understand that the vendor dashboard may also include or link to one or more tools that enable brands to make offers to consumers through the platform. In one implementation, an “offers” button may be placed in the consumer's landing page, where the consumer may view offers being made by vendors, which may be based on activities of the consumer in the platform. In one aspect, these “offers” may be placed and removed by a brand if these are not viewed or acted on by the consumer.

In another aspect, the operator of the platform may develop various promotional strategies designed to provide a benefit to consumers, and also meet promotional or brand building objectives of the vendor; and these strategies may be executed using the platform. For example, consumers may be invited to the platform by a vendor, in conjunction with a promotion. Landing pages may be pre-populated with certain content supplied by a vendor, such as branded rooms that reflect design choices suggested by the vendor, which the consumer may then modify to reflect their taste. While the platform in one implementation is designed to be multi-brand, allowing consumers to explore sets of design choices incorporating products associated with two or more brands, consumers may be invited to log in to an area that incorporates design items associated with one or more brands approved by a single customer of the operator of the platform. For example, two or more brands may use the platform to run a cross-promotion in which an area is presented by the platform that is designed to allow consumers to explore design choices based on products from the two or more participating brands.

In one aspect of the invention, the platform is designed so that it integrates social networking features that allow consumers to easily discover design items of interest to them, manage a “collection” of design items of interest to them, and receive input from social networks regarding design choices, and provide input to their social networks on their design choices. The integration of social networking features streamlines the activities involved in finding design items of interest and exploring design choices based on the design items of interest in a collaborative way, thereby promoting purchase readiness in an efficient and engaging way.

In one aspect, rooms may be “private” or “public” in the sense that they may be publicly viewable or viewable only by the consumer, or those authorized by the consumer. In one aspect of the invention, private rooms may be made viewable by a consumer's social network. In another aspect, design objects are presented in the platform as social media feeds. Design objects are specific digital media objects that are presented to a registered user based on the registered user subscribing to associated feeds such as a product feed, product line feed, and/or brand feed. Once a registered user subscribes to such a feed, relevant updates including updates to a design object or associated information, or new related products and associated design objects, are automatically sent to the registered user by presenting them or making them accessible through the registered user's landing page.

The registered user's landing page present multiple rooms that the registered user has created. In one possible implementation, each room is presented as a thumbnail of the room, and may include a title or theme of the room, which may be input by the registered user. A “share” button may allow the registered user to share each room, and this button may access a further screen that allows the user to select sharing preferences for the particular room. For example, a registered user may feel that a particular room with its design choices is suited to share with a particular friend in his/her social network based on his/her taste. Each thumbnail of the room may present information relevant to social media interactions such as the number of “LIKES” for a particular room.

Each room thumbnail may also be associated with a link that allows the registered user to access information for the specific design items incorporated in the particular room. This may be referred to as a “gallery”. A user may click on the “gallery” to view product information related to the design items. In another aspect of the invention, when a user clicks on a room thumbnail that relates to a room accessible to them (either as a registered user in their own area, or as a user with whom another user has shared another room), the user may be presented with a larger view of the room and optionally the design items incorporated into a room may be presented as a series of thumbnails organized as a scrolling bar or dock The scrolling bar may be presented below the view of the room or above, or in some other arrangement.

In one aspect, if a room is shared with another user, the other user may be presented with the image of the room and the associated scrolling bar, without the ability to modify the room design. Alternatively, if a first user shares a room with a second user, the first user may provide permission to the second user to make changes and then the modified room may be presented to the first user as a new room on their landing page, associated with the second user's identity.

In another aspect of the invention, the landing page presents a “collection” link or equivalent. This includes an inventory of “favourite” design items of a registered user. Favourites may be selected by a user, for example by accessing a larger “inventory” or equivalent and click on an item. The inventory may consist of a library of items, which may be categorized in a number of ways, including based on type of item, manufacturer, colour and so on. Various tools may be used to navigate through the content. The platform may also include various intelligent tools for filtering content based on preferences. Also, for example if the registered user is accessing the platform through an area established in conjunction with a promotion or a cross-promotion, the inventory may contain a sub-set of items available across the platform.

Favourites may also be included automatically into the collection based on a number of criteria, such as selection by a friend of the registered user, or a particular friend whose design choices the registered user trusts. The platform allows the registered user to configure various preferences including for example the registered user may define a minimum number of “likes” or a trending profile associated with a product before a design item is pulled into their collection. The analytics utility may also analyze a registered user's preferences and design preferences and suggest from time to time a design item for incorporation into the registered user's collection. This feature may also optionally be turned off by a registered user.

Also, a registered user may visit for example public rooms of another user, a featured room on a main page associated with the platform (which may consist of a branded room or a highly ranked room that its creator has agreed to share), or a room that has been shared with them by another user. In one aspect, the registered user may at any time “LIKE” a brand or a product or a manufacturer. In another aspect, a user may click on for example a thumbnail of a product and select “PUT IN MY COLLECTION” or equivalent, and thus automatically update their collection to incorporate the appropriate design item.

A skilled reader will understand that various intelligent and automated features may be incorporated into the platform that improve the user experience and provide valuable suggestions to users. The analytics utility may for example include one or more extractors for extracting information design choice information, one or more mechanisms for clustering users based on their design choices, and based on this making suggestions to registered users based on other design choices or preferences of other similarly situated users. A skilled reader will understand that various functions and features of this nature are possible.

What follows is one example of a possible room creation workflow, using the tools and features of the present invention. A registered user optionally selects a room composition mode or equivalent. A registered user may select a room type from a list of room type profiles such as “living room” and “studio” versus “gallery”. If the registered user drags their cursor or other input means on for example the floor or the wall in the composition window, then floor options or wall covering options appear respectively. The options displayed may depend on the user's settings or preferences and also optionally the library portions assigned to the user (for example if the registered user's area is sponsored by one or more brands, then options may be restricted to the one or more brands). Alternatively, the user may be presented with a range of options for navigating between design items such as manufacturers, product lines, products, and so on. The user picks design items, and may select features related to design items such as colour and other parameters related to same design item. Once the relevant parameters have been selected by the user, the selection is complete and the registered user clicks “OK” or equivalent and this initiates the platform to select the from the object library the corresponding rendered 3D design object, and this is integrated to the virtual physical environment in the composition window. In one aspect, design objects integrate to the virtual physical environment based in part on their parametric space attributes (as discussed previously). For example a design object representing a rug defaults to placement on the floor in the centre of the room, as presented in a perspective view. A design object representing a couch may default to placement adjacent to the back wall of the room. Once the selected design objects are integrated to the virtual physical environment, the registered user may now move the design objects around in the virtual physical environment, based on the applicable parametric space attributes. The registered user may also select a design object to access one or more menus for further modification of attributes on the fly. Once different attributes are selected, the platform is configured to automatically access the different design object that corresponds to the new attributes from the object library, and replace the previous design object with the new design object in the virtual physical environment automatically.

In another aspect, to the extent that the parametric space attributes permit manipulation of the design objects, such as their rotation, dragging to a new location and so on, the platform is configured so that the registered user may manipulate design objects within the virtual physical environment in a flexible manner that is designed in aggregate to enable registered users to explore a variety of different design choices.

Once the registered user achieves the result intended in this particular composition session, the virtual physical environment with its current attributes and settings is stored. Optionally the registered user accesses the virtual physical environment and repeats one or more of the steps set out below.

Optionally the registered user may initiate one or more social media interactions involving the virtual physical environment such as sharing the room with others or publishing the room to another area of the website such as for example an area where other users may rank compositions in certain categories. Various other engaging features are possible such as contests and games involving composed design content using the platform. For example, the platform may includes galleries of galleries (of rooms) and design contests may be launched for featured positions in the gallery of rooms.

As previously stated, each design object includes or links to automatically programming that controls how the design object relates to other design objects, and to aspects of the room's virtual physical environment. For example, design objects cannot occupy the same space, couches can be placed in defined positions that meet room design criteria and so on.

In one aspect, the platform uses high fidelity images with 3D attributes (i.e. depicting 3D physical objects in a way that their 3D features are visible) in a unique way. Prior art solutions are generally low fidelity and vector based, which means that representations of objects cannot be dragged in real time, rather attributes are selected for example by changing attributes or interacting with low definition composites, and then a new scene with the changes must be rendered each time. Instead, in the present platform, a set of parametric space attributes is defined that maps to apt design choices associated with the relevant design items; the design objects are rendered for every position that is possible in a coordinate system defined for the virtual physical environment, based on the parametric space attributes; when the registered user for example indicates his/her intent to move the design objects in a way that involves a change form one parametric space attribute to another, then a design object is removed and replaced with a second design object that corresponds to the change.

For example, it may be defined that in a particular room a couch of a certain size may be placed in a certain sub-area of the room; and the couch may be rotated at certain angles relative to the back wall (e.g. parallel to the back wall, 45 degree angle to the back wall etc.). Design objects are rendered to reflect the possible locations and rotational positions of the couch, such that when the user attempts to move the couch and rotate it to an angled position, the input from the user is captured, interpreted by the platform, and the corresponding rendering is accessed an integrated to the room. This approach resolves numerous technical challenges and permits manipulation of high-definition 3D images in a way that is consistent with the user's intent yet permits delivery in an Internet browser linked to computer device having average hardware/software/middleware resources.

In another aspect, the platform has been configured such that various design objects that make up the virtual physical environment are automatically linked, and yet changes in for example the positioning of one design object does not affect the remaining design objects or the rest of the composition. A skilled reader will understand that this aspect may be implemented using a number of different suitable algorithms.

Another implication of the use of parametric space attributes, in the manner described, is that the virtual physical environment integrates logic that presents as though each design object was aware of its function. For example, if the registered user selects an item such as a vase that is meant to be placed on a table, but there is more than one table on which the vase could fit in a particular room, the registered user may be prompted with the question “WHICH TABLE?) and highlights (or uses another visualization technique) each of the design objects in the room corresponding to tables that could receive the vase based on parameters such as size. A skilled reader will appreciate that many such logical elements may be implemented to the system by encoding the parametric space attributes accordingly.

In another aspect of the invention, each design object is also encoded with “class” information that streamlines the process of integration and manipulation of design objects. For example, chairs are organized in a “chair class” and the “chair class” may be associated with particular rules that define where chairs may be positioned (on a default basis and also based on user intent) and how they may be moved (for example rotated). These design choices permit the object library to be kept at a manageable size yet enables the platform to give effect to substantially all user selections that work from a design perspective. In another aspect of the invention, when a user clicks on a design object other related information may be presented such as the website of the manufacturer and so on.

In yet another aspect, the platform may include an application programming interface (API) that enables the computer system to connect to remote computers for example to access updates to information and integrate these with the platform's databases and libraries, and also for example to allow users to link directly from the website of the present invention to appropriate information or resources on third party sites such as a vendor website. The API in this way may facilitate online ordering directly from the platform into a third party online commerce website. The API may also push sales leads to vendors based on interest expressed through the platform that reaches a specified threshold.

In another aspect the vendor dashboard may enable a brand administrator to access various information regarding user activities related to their brand or specific product lines and specific products. The vendor dashboard may enable the segmentation of this information based on demographics, location and other relevant criteria.

In one example of a possible implementation of the present invention, the platform incorporates techniques for improving the performance of the composition functionally of the present invention. For example, in order to improve performance, a workflow and feature was designed to enable design objects to be pulled from the back-end database and integrated with the virtual physical environment in an Internet browser while avoiding slow loading or loading failures that had been occurring using prior art approaches. The platform utilizes, in one possible implementation, a modified image tiling technique in order to meet performance goals. The technique creates one very large image per object that contains all smaller bitmap images relate to the object. Consequently all the relevant images are retrieved through a single request, which reduces overhead. However, it was determined that Flash could not handle 1,440 px by 100,000 px images at 72 dpi due to memory limitations. Using the modified image tiling technique the initial image may be split to produce several images where each image contains all positions for one single rotation. This created an image of a maximum 228 px by 2448 px with a total of 588,144 pixels, which is 28.5 times less than the maximum allowed. In addition to this, the disk space was also reduced to an average of 69.7 KB. Image tiling was facilitated by development of a custom utility that implements a proprietary algorithm for splitting the images and tiling the images as described. The algorithm was also designed to create merged PNG tiles by superimposing smaller PNG images to a large transparent PNG image. Additional logic was incorporated to extract specific images from a tile as needed in the application.

In another particular aspect, pixel coordination calculations may be used to allow the images to be placed anywhere in the virtual physical environment, if this is permitted based on the applicable rules. As further aspect, logic is integrated into the platform to identify objects with incorrect metadata so that the images may be properly rendered on the Internet browser once a design object is selected. These particular aspects of implementation permit the fluid movement of design objects in the 3D plane of the composition window and allows the platform to simulate 3D rendering using pre-rendered bitmap images without any lags.

### Analytics

In one possible implementation of the present invention, the computer system may include a logger that logs each event that relates to an activity of a registered user of interest to the platform, and by extensions the vendors associated with the platform. For example, each time a user engages with a product by placing it into their room or clicking through to the website, this event is logged, and logged information is made available to the analytics utility to generate analytics data for example for presentation to vendors through the vendor dashboard.

A skilled reader will understand that privacy requirements will restrict the way in which specific user interest information may be used. In one aspect, user interest information may be aggregated. In another aspect, the platform is designed to provide incentives for users to share their interest information for example with vendors. These incentives may be for example coupons, discounts, redeemable points, points that may result in donations to charity, badges, points to be used in social games and so on. Various types of incentives are possible. In one aspect of the invention, the platform—instead of presenting targeted ads that clutter the platform experience—users may be motivated to allow their user interest information to provide high value sales leads to vendors.

Users of the platform indicate their preferences (such as favorite brand, favorite product from a brand), provide comments regarding products and so on. With the user's approval this information may be shared dynamically. Otherwise comments may be depersonalized and information aggregated and presented to vendors for example through the vendor dashboard. Information regarding for example what products users are selecting and in what circumstances, and how these products are being shared through the platform, has never been produced before, and is very valuable to vendors. The information for example provides valuable trend information on changes in styles, and emerging trends that are consumer directed rather than vendor dictated. This affords an opportunity for vendors to bring products to market that have better appeal.

From a vendor perspective, this is a platform where every room a user creates becomes an ad for every item in that room. The social network is the distribution channel for that ad. The more a user shares, the more friends the user has, the more their product gets seen. Accordingly, the platform builds community around products which is a highly effective marketing approach given social media that prior art solutions have not employed previously for design items. Rooms are published to wider social networks such as FACEBOOK™ increasing visibility.

In contrast, in most retail environments it is difficult to show all the inventory that a store has to offer, In a virtual environment there are no limitations of floor space so the amount of inventory becomes limitless, while the platform as described provides useful mechanisms to navigate through content and filter content including based on social media interactions.

The present invention in one aspect provides an engaging way to explore options in what amounts to an interactive 3D catalogue in which design opportunities can be explored in away that is far more evocative of physical environment that the catalogue ultimately relates to.

The ability to disseminate large amounts of product information efficiently and the ability to create engagement around these products cost effectively creates enormous value for vendors, especially manufacturers. A skilled reader will understand that the platform may be configured to measure and also to present (as discussed) various types of metrics. For example: (A) Per impression metrics: every time a user adds an item to their room. (B) Per click-through: every time a user clicks through to a brand or retailer, or e-commerce website. These metrics may be captured by brand name, product name and user ID.

For reporting, reports may be categorized for example by brand, and in each brand category it may be shown which products were placed in public rooms and how often. In one example, the Hickory Chair (brand/manufacturer) has x# of impressions in public rooms. Then, the number of impressions for that category, and the associated category may be shown. Similar information may be shown for each manufacturer. The same information may also be generated for private rooms, and information for private rooms and public rooms may be kept as separate reports.

The platform may also measure click-throughs to vendor websites. Each of these URL's will be unique to each brand therefore permitting the metrics to separate click-throughs to the brand, and this may also be separated by brand website, retailer website and e-commerce site.

The platform may also capture and report on various user metrics including for example (A) average # of rooms active users have (total, then how many are public and private); (B) how many times a product is getting viewed in public rooms; (C) average # of impressions per active user, per room, per month; (D) average time on site by users; (E) average # of items users have in their rooms; (F) how many times a user shares a particular item per month; (G) how many times a user “takes” an item from somebody else's room, etc.

### System Implementation

System 50 may include a central server 54 that connects, via a first link 58 to a profile engine 62 and via a second link 66 to a central database engine 70. Central server 54 also connects to a wide area network 74 such as the Internet.

Network 74, in turn, interconnects central server 54 with one or more content servers 78-1, 78-2 . . . 78-n. Generically, these are referred to as “content server 78” and collectively they are referred to as “content servers 78”. This nomenclature is used elsewhere herein. Network 74 also interconnects central server 54 with a financial service clearing infrastructure 82.

Network 74 also interconnects central server 54 with one or more client machines 86-1, 86-2 . . . 86-p.

Central server 54 can be based on any desired server-type computing environment, including appropriate configurations of one or more central processing units (CPUs) configured to control and interact with memory (including volatile memory such as Random Access Memory (RAM), and non-volatile memory such as hard disk drives or FLASH drives, or a Redundant Array of Inexpensive Disks (RAID) or cloud-based storage), network interfaces (to connect to link 58 and link 66). Central server 54 can also be configured to include input devices such as a keyboard or pointing device or output devices such as a monitor or any of or all of them, to permit local interaction. Other types of hardware configurations for central server 54 are contemplated. For example, central server 54 can also be implemented as part of a cloud-based computing solution, whereby the functionality of central server 54 is implemented as one or more virtual machines executing at a single data center or in a mirrored form across a plurality of data centers. The computing environment of central server 54 can also include remote access capabilities in lieu of, or in addition to, any local input devices or local output devices. Any desired or suitable operating system can be used in the computing environment of central server 54. The computing environment can be accordingly configured with appropriate operating systems and applications to effect the functionality discussed herein. Central server 54 is, amongst other things discussed herein, configured to provide graphical interfaces on client machines 86, typically in the form of web pages although other hosting formats are contemplated. In general central server 54 is configured to provide a social media platform as will be discussed further below.

Profile engine 62 can be based on a server-type computing environment, much along the possible lines of the computing environments described in relation to central server 54. Profile engine 62 is configured to maintain profiles 94 associated with various individual subscriber accounts 94, which are in turn associated with each client machine 86, the details of which will be discussed further below. In variations, a plurality of profile engines 62 (not shown in the Figures) can be provided which aggregate profile information from a plurality of different linked subscriber accounts. For example a Facebook™ subscriber account (not shown and not to be confused with subscriber account 94) or mobile telephone subscriber account (not shown and not to be confused with subscriber account 94) and each of those accounts may in turn have their own individual profiles, which are then linked to provide a merged profile 90 that can be used according to the teachings of this specification. In variants, profile engine 62 is incorporated directly into central database engine 70 such that profiles 90 for each subscriber account 94 are either stored within its respective subscriber account 94, or locally to each respective subscriber account 94.

Central database engine 70 can also be based on a server-type computing environment, much along the possible lines of the computing environments described in relation to central server 54. Central database engine 70 is configured to store subscriber accounts 94 including configuration data 96 that is received via client machines 86. As will be discussed in greater detail below, such configuration data in a present embodiment comprises configuration data 96, which includes graphical data representation of a room and its furnishings, where such graphical data can be modified via client machines 86 that satisfy credential authentications to perform modifications of subscriber accounts 94. Central database engine 70 also maintains a furnishings database 97 which stores a furnishing inventory of furnishings 108 which will be discussed further below

Link 58 and link 66 can be implemented as part of network 74, but in a present implementation it is contemplated that profile engine 62 and central database engine 70 are local to central server 54 in which case link 58 and link 66 can be implemented as part of a local area network. Alternatively, the functionality of profile engine 62 and central database engine 70 can be incorporated directly into central server 54 obviating link 58 and link 66 altogether. Alternatively, instead of a central server 54, the computer system of the present invention may be implemented using two or more servers and in fact may be implemented using a cloud computing network or a distributed computer architecture.

Each content server 78 can be also based on a server-type computing environment, much along the possible lines of the computing environments described in relation to central server 54. Each content server 78 can maintain third-party furnishings 101 that can be used to populate the configuration data that is maintained in central database engine 70. Third-party furnishings 101 can be imported as furnishings 108 into database 97, and this aspect will be discussed further below. In certain implementations, each content server 78 is maintained by different entities or enterprises and can be based on, in whole or in part, pre-existing e-commerce websites that are hosted by those entities. Content servers 78 will be discussed further below.

Each financial service clearing infrastructure 82 is also based on computing environment that is configured to finalize financial transactions whereby funds are exchanged for a particular good or service. It is contemplated that each financial service clearing infrastructure can be based on pre-existing financial service infrastructures, such as those maintained by Paypal, VISA, Mastercard or the like. In general, financial service infrastructures enable the processing of financial transactions in relation to e-commerce activities within system 50 and are based on existing infrastructures. In certain implementations, one or more accounts 94 can be configured to effect payment transactions via clearing infrastructure 82.

Client machines 86 can be based on any suitable computing environment, and the type is not particularly limited. For example, one or more of client machines 86 can be traditional client computers, such as a desktop computer, a tablet computer, a laptop computer, or mobile computing device. In FIG. 1, client machine 86-1 and client machine 86-p are traditional desktop computers, responsive to mouse, keyboard and other potential input methods, while client machine 86-2 is a tablet computer configured to receive input via a touch screen, responsive to touch-gestures and an optional pop-up graphical keyboard responsive to input from the touch screen. The teachings herein accommodate such various different types of computing environments. A physical printer 95 is also shown, by way of example, as connected to client machine 86-p, though a printer may be connectable to any of client machines 86 for printing a physical document.

As noted above, an account 94 can be associated with a client machine 86 by provision of proper account credentials. Upon provision of such credentials, the means by which such association is effected is not particularly limited. However, presently it is contemplated that each client machine 86 will include an absolute identifier that is uniquely associated with each client machine 86 and a relative identifier that is associated with its respective account 94 and with the absolute identifier, thereby providing a logical link between the account 94 and the client machine 86. Such a linkage can be temporary where a set of credentials can be used to access the respective account 94 via the respective client machine 86. The linkage can also be more persistent, as is common in the mobile telephony context when client machine 86 is a mobile telephone that is associated with an account 94 belonging to a particular subscriber through a subscriber identity module (SIM) card or similar means depending on the applicable telecommunication standard.

Thus the specific nature of a given relative identifier and a given absolute identifier can vary according to the particular computing environment of each client machine 86 and the nature of its connection to network 74. As a non-limiting example, in a mobile telephony context, an absolute identifier can comprise an International Mobile Equipment Identity (IMEI) associated with a given client machine 86 that is implemented as a mobile smart phone. Likewise, in the mobile telephony context, relative identifiers can comprise an International Mobile Subscriber Identity (IMSI).

Each account 94, and its corresponding data configuration 98, can thus be accessed from any client machine 86 provided proper account credentials (e.g. account holder name and password, or the like) are provided at the client machine 86 and validated at central server 54. For purposes of further discussion, it will be presumed that account 94-1 is validly authorized to be accessed from client machine 86-1, account 94-2 is validly authorized to be accessed from client machine 86-2, and account 94-p is validly authorized to be accessed from client machine 86-p.

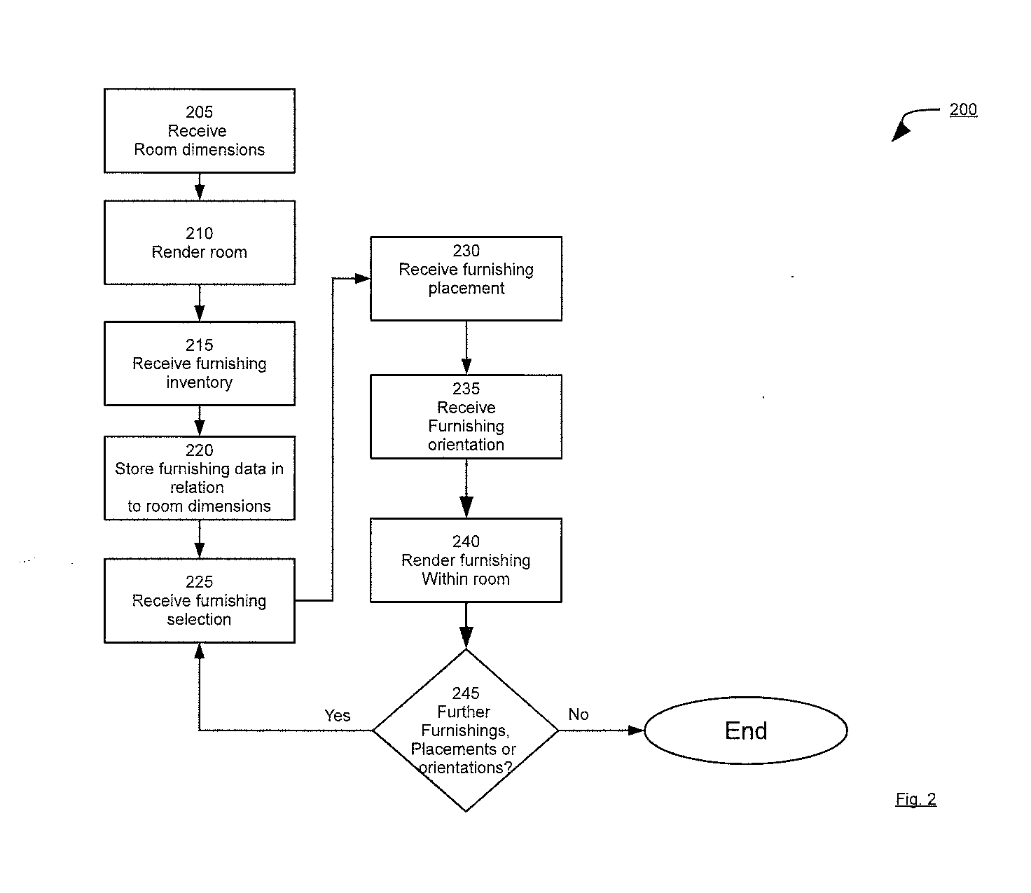

Referring now to FIG. 2, a flowchart depicting a method for managing subscriber account configuration data is indicated generally at 200. Method 200 can be performed on system 50, and for further understanding of the general aspects of system 50 and method 200, method 200 will be described in relation to its performance on system 50 using specific but non-limiting examples. It is to be emphasized, however, that method 200 need not be performed in the exact sequence as shown; and likewise various blocks may be performed in parallel rather than in sequence; hence the elements of method 200 are referred to herein as “blocks” rather than “steps”. It is to be understood that method 200 can be implemented on variations of system 50 as well.

Block 205 thus comprises receiving a set of room dimensions. This step is optional as in most implementations of the present invention, dimensions are not user defined but rather are defined by the platform. In an alternate embodiment, the room dimensions are provided at a client machine 86 and stored in configuration data 96 respective account 94 being accessed from that client machine. Three dimensional dimensions are presently contemplated. The room dimensions can be received in a variety of ways to specify the length, height and width of each wall in the room and the angular relationships between each of those walls. Different graphical interfaces can be provided at client machine 86 to receive these dimensions. For example, a purely text-based graphical interface could be provided that receives numeric dimensions and units for each wall, and a specification for the angle between adjoining walls. A visual graphical interface could also be provided that receives lines, rectangles, squares, cubes or other geometric shapes, with each side or surface representing a wall. Prompts can then be provided for textual entry of the dimensions for each wall. Alternatively, “dragging” type hand gestures or mouse inputs can be received to permit a more visual dimensional adjustment of the basic shape that is selected. As another example, in more sophisticated implementations, one or more photographs of an actual room could be provided that undergo image processing to ascertain, or at least estimate, the room dimensions and then provide an opportunity for manual correction or adjustment of those dimensions. As another example, block 205 can be configured to import a set of room dimensions from another software application such as a computer aided design (CAD) application. Receipt of dimensions and other specifications for doors, walls, windows and other structural features can also be effected at block 205. Combinations of the foregoing techniques can also be employed or offered at block 205.

Further in accordance with an alternate embodiment in which dimensions are user defined, Block 210 comprises rendering a graphical representation of a room according to the dimensions received at block 205. Example performance of block 210 is shown in FIG. 3, which shows the generation of a graphical representation of a portion of a three-dimensional rectangular room 104-2, with three walls showing and the fourth wall not shown but implicitly present as behind the perspective shown in FIG. 3. The ceiling is likewise not shown. In an implementation, the walls, floors are preferably shown to scale, according to the dimensions provided at block 205. While not shown, it is contemplated that the room can be shown from different perspectives so that different views of the walls, ceiling and floor from those perspectives can be seen according to selected input via touch screen gestures, keyboard or mouse or other input device. While not shown as a step in method 200, at this point a graphical interface can be invoked to permit further adjustments to the dimensions or appearance, thereby offering an opportunity to return momentarily to block 205.

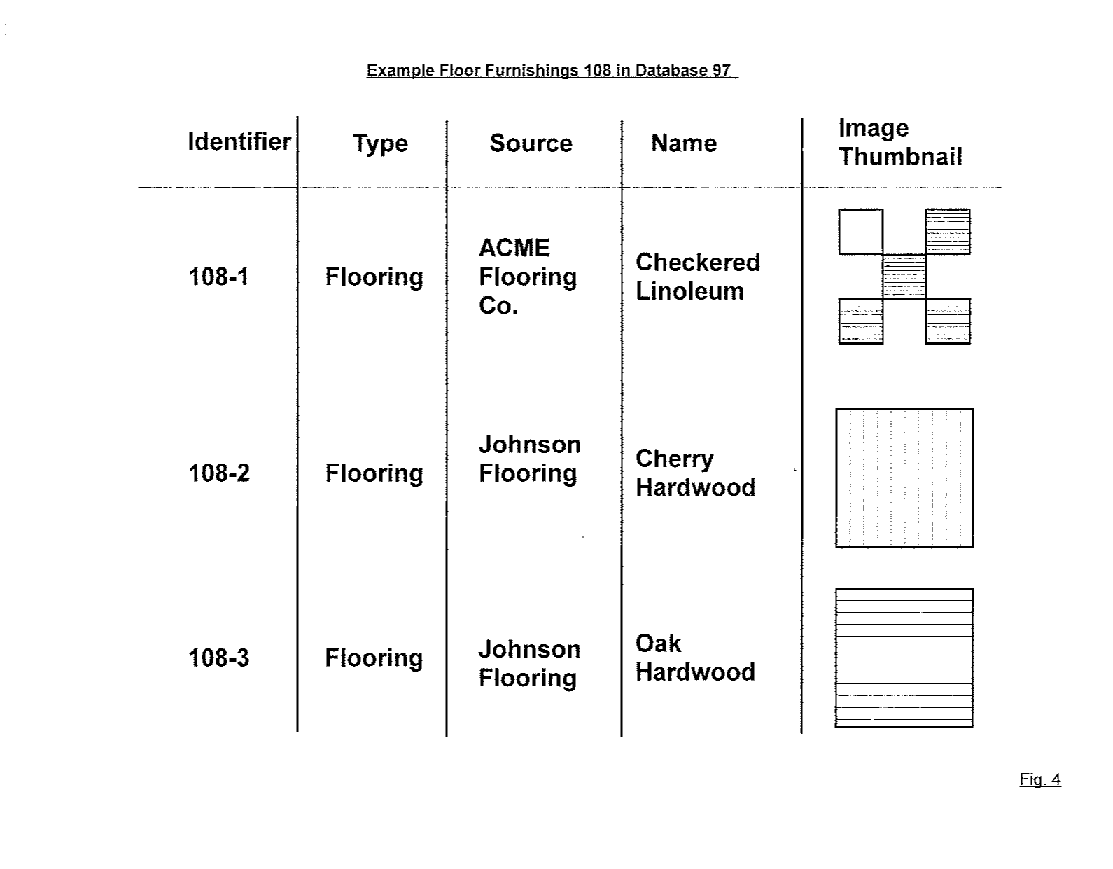

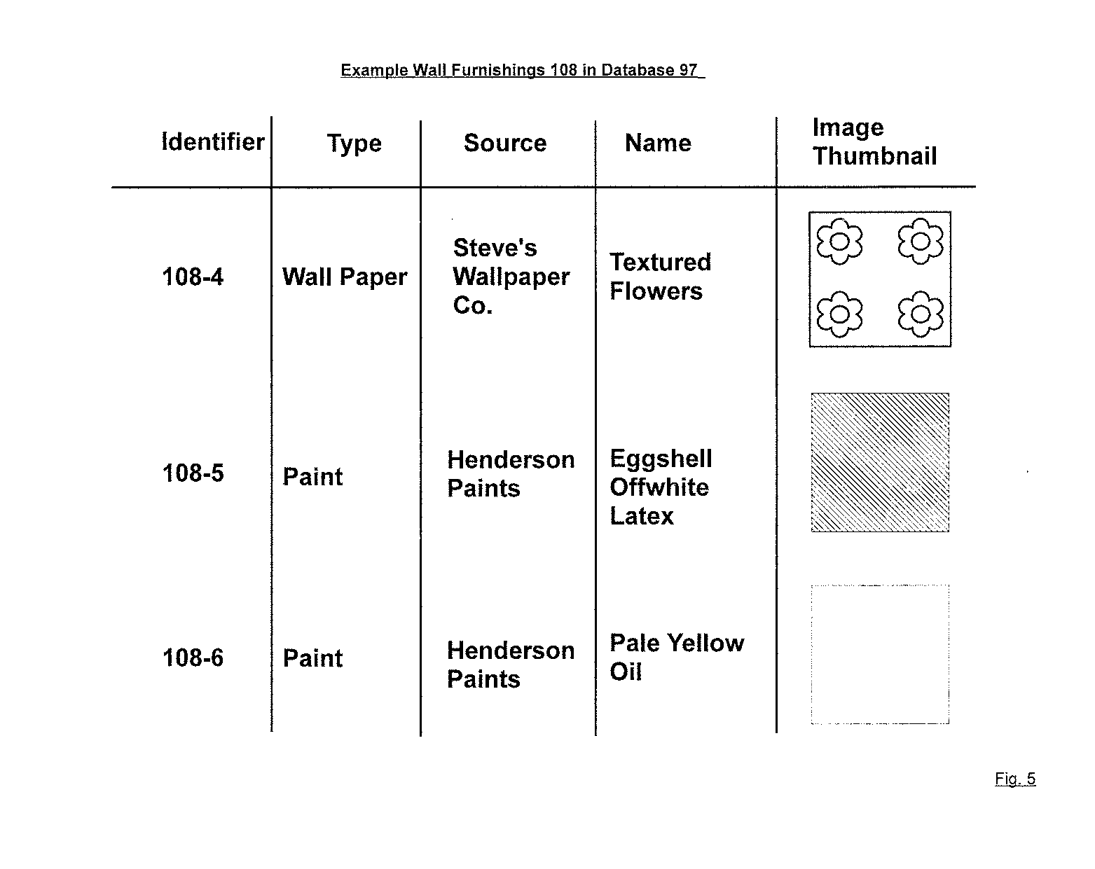

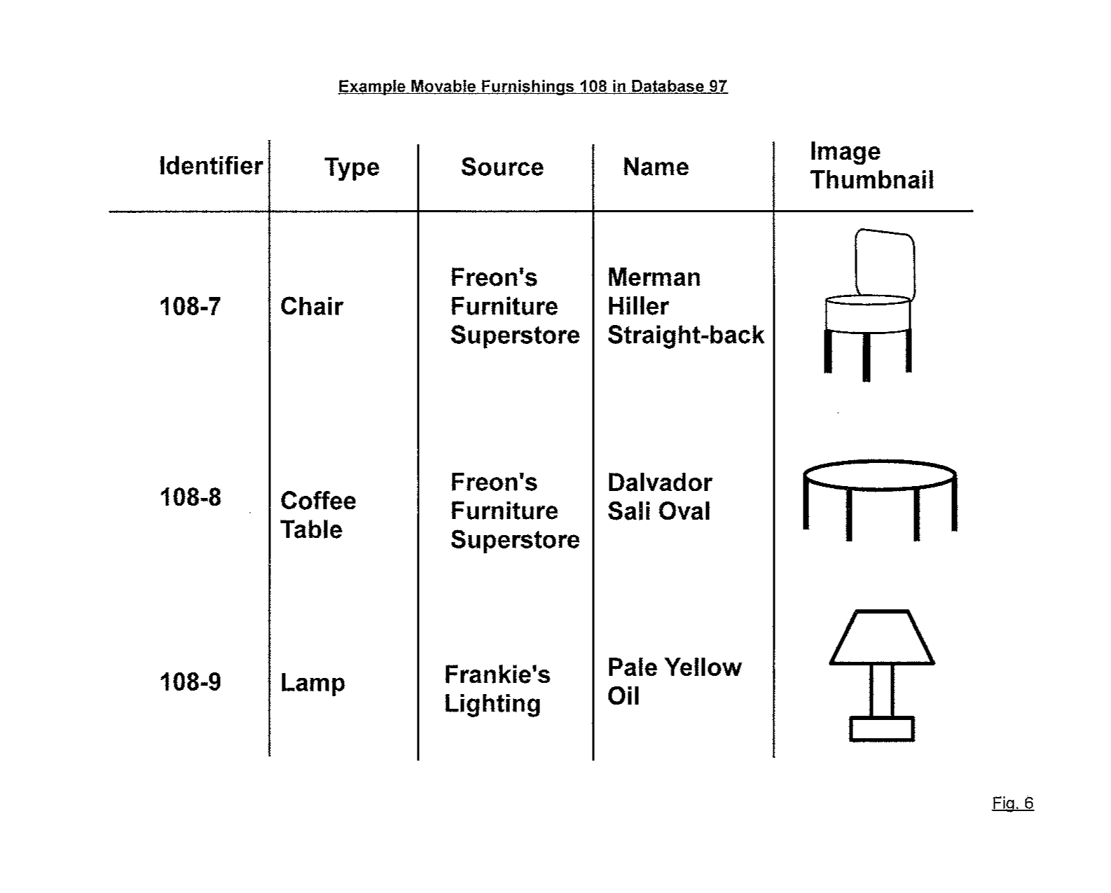

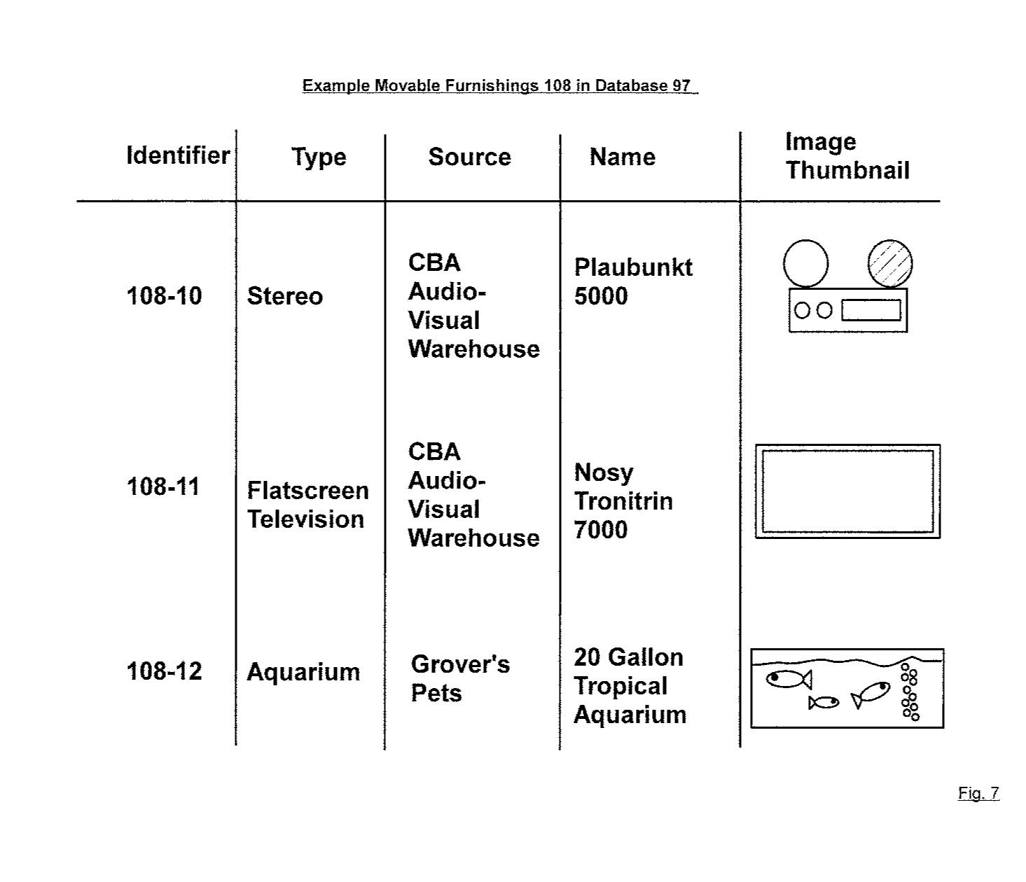

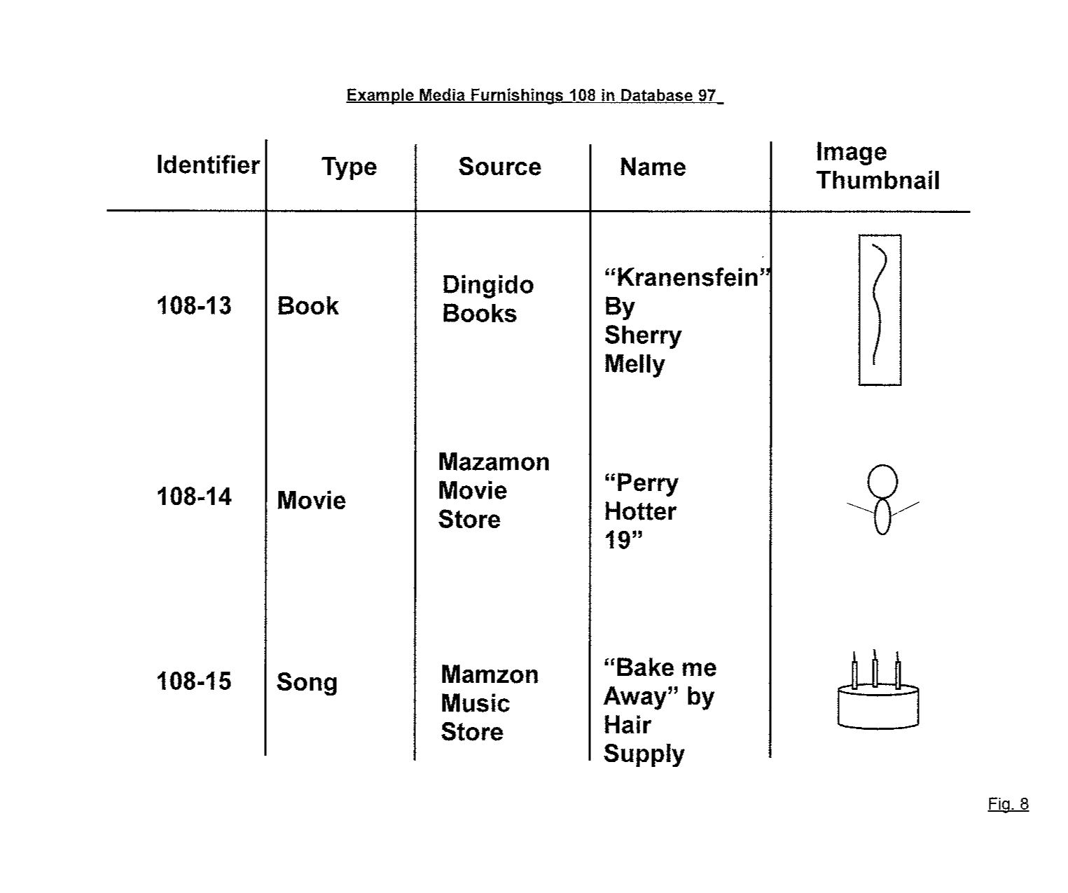

Block 215 comprises receiving a furnishing inventory from one or more furnishing databases. The term “furnishing” is not particularly limited and includes immovable decoratives such as trim, moldings, paints, wall papering, floorings as well as movable decoratives such as wall hangings, window coverings, chairs, tables, sofas, lounges, benches, lamps, lights, statues and other art, stereos, televisions, computers, shelves, racks, fish tanks, as well as media items including books, music, and videos. However, in order to provide some concrete, but non-limiting examples, FIG. 4, FIG. 5, FIG. 6, FIG. 7 and FIG. 8 show some specific furnishings 108 that can be part of a furnishing inventory stored within furnishing database 97.

The database structure shown in FIG. 4, FIG. 5, FIG. 6, FIG. 7 and FIG. 8 contemplates Identifier, Type, Source, Name, links to manufacturer and retail websites, price, colour, and Image Thumbnail fields. This is a non-limiting example of such a structure and other types of structures will now occur to those skilled in the art. The Identifier field is a unique index or other identifier number. For convenience, the example identifiers correspond to other reference characters used herein, but any type of unique identifier can be used. The Type field specifies where in room 104-2 (or other room) such a furnishing may be used. The Source field specifies an entity or an enterprise that can provide the particular furnishing. In certain implementations, the data within the Source field can reflect an association or correspondence between the present furnishing 108 and a third-party furnishing 101 that is hosted on a content server 78 and the entity or an enterprise that operates that content server 78. Such an association or correspondence can include, for example, a web page address (not shown) stored within the Source field that points to a corresponding third-party furnishing 101 hosted on a particular content server 78. This is one manner by which a linkage can be made between third-party furnishings 101 and furnishings 108 stored within central database engine 70, and can reflect or track the fact that a particular furnishing 108 may have been imported from a third-party furnishing 101. The Name field specifies a make, model, brand or other colloquial or friendly name to correspond with the identifier. The Image Thumbnail field specifies an image file of a portion or a reduced size of the particular furnishing 104.

More specifically, in relation to FIG. 4 various flooring options are shown, which can be used to modify the appearance of the floor area of room 104-2. All floors are branded and also link to the manufacturer and retailer.

FIG. 5 shows various wall options which can be used to modify the appearance of one or more walls of room 104-2. Wall options are also branded and will link to the paint and/or wallpaper manufacturer.

FIG. 6 shows various movable furnishings that can be used to fill the living space of room 104-2. Note that chair furnishing 108-7 and coffee table furnishing 108-8 would be placed on the floor space of room 104-2, while lamp furnishing 108-9 would be placed on table furnishing 108-8. Database 97 can be further configured to include dependencies, such as by making lamp furnishing 108-9 dependent on table furnishing 108-8, such that lamp furnishing 108-9 could only be selected if table furnishing 108-8 was selected.

FIG. 7 shows additional examples of various movable furnishings, all of which are similar in nature to lamp furnishing 108-9 in that a database dependency can be created requiring the selection of table furnishing 108-8 as a placement surface for the furnishings shown in FIG. 7. Or, as another example, television furnishing 108-11 can be made alternatively dependent on a table furnishing 108-9 or a wall surface of room 104-2 such that it must be mounted on a wall surface.

FIG. 8 shows examples of media furnishings in the form of a book furnishing 108-13, a movie furnishing 108-14 and a song furnishing 108-15. Of note is that while the image thumbnail for book furnishing 108-13 can be a physical image of the book in question, the image thumbnail for movie furnishing 108-14 can be a movie poster or a still frame from the actual movie production in the Name column, while the image thumbnail for song furnishing 108-15 can be an album cover or album artwork for song in the Name column. Again, in FIG. 8, dependencies can be created so that media furnishings can only be selected after a logical corresponding furnishing has already been selected. For example, book furnishing 108-13 can be dependent on the selection of table furnishing 108-8 (or a bookshelf furnishing, not shown) so that there is a location to place book furnishing 108-13. As another example, movie furnishing 108-14 can be dependent on the selection of television furnishing 108-11 (or the television furnishings or computer furnishings or video player furnishings, not shown) so that there is an appropriate device upon which movie furnishing 108-14 can be shown. As another example, song furnishing 108-15 can be dependent on the selection of stereo furnishing 108-10, or another furnishing, not shown, that in its physical implementation is capable of playing music.

In another aspect, this presents another opportunity for brand engagement. If a manufacturer sees that a user has their television in their room for example, they can offer the user a video (trailer, feature, show, promotional, or instructional) to play on their television. When a users friend comes over, and they too can watch that video but cannot take it for themselves. This aspect mirrors the real world where a friend can visit another and enjoy what that friend has to offer but cannot take it home for themselves without prior permission. Audio devices may link to the users playlist offering the opportunity to purchase tracks for themselves.

As a further variation, aquarium furnishing 108-12 can have an image thumbnail showing it as empty, and dependent furnishings (not shown) can be provided comprising specific species of fish that can be placed in the aquarium furnishing 108-12.

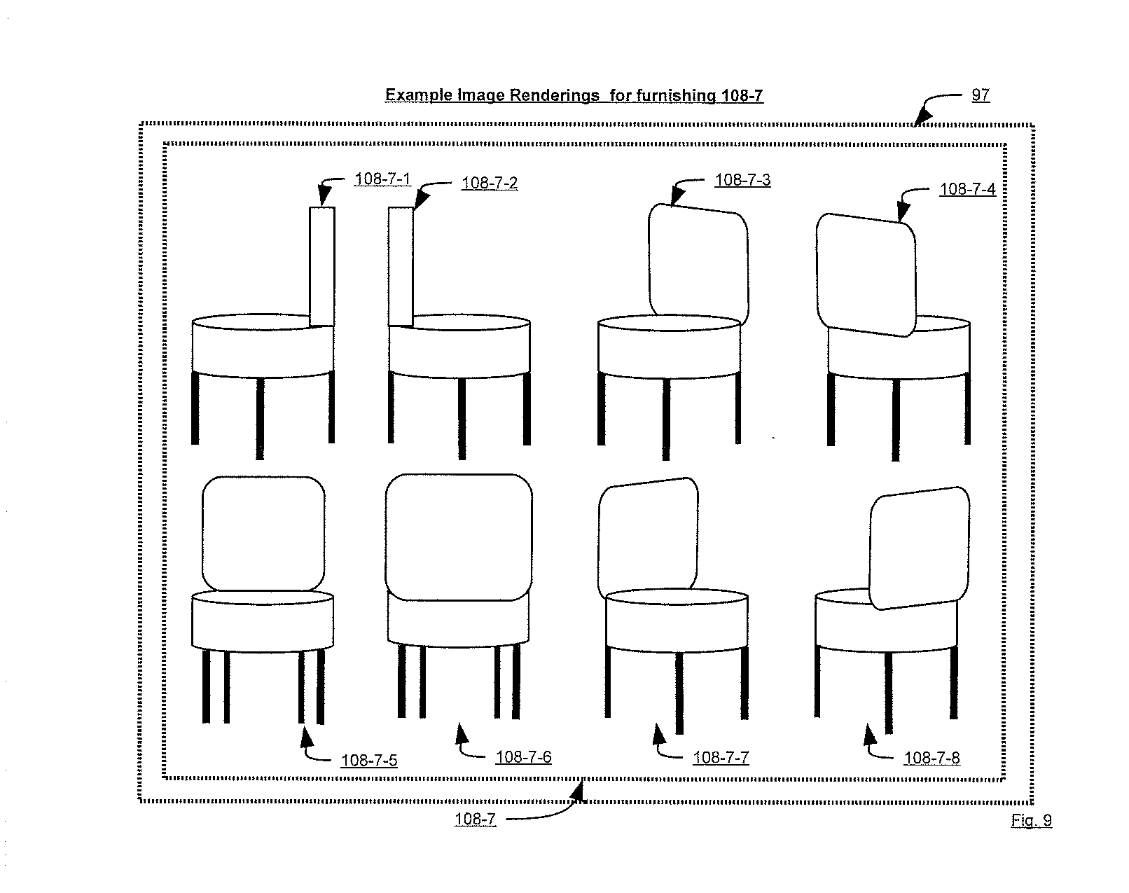

There can be further data stored in relation to each furnishing 108 stored within database 97 which can then be used to populate the image of room 104-2. For example, FIG. 9 shows eight views of chair furnishing 108-7. Each view shows chair furnishing 108-7 from another perspective. Chair furnishing view 108-7-1 shows a right side view of chair furnishing 108-7. Chair furnishing view 108-7-2 shows a left side view of chair furnishing 108-7. Chair furnishing view 108-7-3 shows a right front side perspective view of chair furnishing 108-7. Chair furnishing view 108-7-4 shows a left rear side perspective view of chair furnishing 108-7. Chair furnishing view 108-7-5 shows a front view of chair furnishing 108-7. Chair furnishing view 108-7-6 shows a rear view of chair furnishing 108-7. Chair furnishing view 108-7-7 shows a left front side perspective view of chair furnishing 108-7. Chair furnishing view 108-7-8 shows a right rear side perspective view of chair furnishing 108-7. Such views can be used to show chair furnishing 108-7 in situ within room 104-2.

Views of the type shown in FIG. 9 can be maintained for all physical furnishings within database 97, (i.e. all furnishings 108 shown in FIG. 6 and FIG. 7) recognizing that a different number of views may be stored: for example, lamp 108-9 need not have eight views since lamp 108-9 appears the same from all lateral directions. Indeed, additional (e.g. top, bottom) or fewer views can be provided depending on a desired richness of experience. Such views can also be in the form of continuous video showing the particular physical furnishing 108 from all angles.

For non-physical furnishings, such as movie furnishing 108-14, or song furnishing 108-15, then the additional data stored in database 97 in relation to such furnishings can be in the form of a data-file representing all or part of the particular media. Furthermore, book furnishing 108-13 may comprise the views as shown in FIG. 9, and may also comprise a data file representing the actual contents of the book, i.e. the ‘e-book’ version. Alternatively, the additional data for media furnishings can be linkages to an existing media database locally stored on client machine 86, or a cloud based media database account stored on one or more content servers 78 or elsewhere on network 74.

Further dependencies and variations on the foregoing are contemplated. For example, just as various wall covering options are shown in FIG. 4, so can various colours, sizes, materials and other options be provided as dependencies for movable furnishings shown in FIG. 6 and FIG. 7.

The foregoing provides some specific, but non-limiting examples of how database 97 can be populated with furnishings 108, and introduces the concept of how furnishings 108 can be populated with, or imported from, furnishings 101 from different and disparate third party content servers 78. Block 215 thus contemplates that various furnishings 108 can be selected at a particular client machine 86 (e.g. client machine 86-2) for virtually decorating a room (e.g. room 104-2) with those furnishings 108. This is where brand engagement has another opportunity to become viral through the platform. A friend visiting another's room will have the ability to take that item and place it in their own room. This provides another metric, showing who took what item, and optionally a per impression charge to the manufacturer

In another aspect of the invention various business models for monetizing interactions through the platform, including charges similar to fees associated with ad placements and more specifically per impression charges. The logic is that the viewing of specific product information by a platform users is similar to placement of an ad search or non-search web pages, except in effect the link is more direct as consumers may or may not view ads presented by they are interacting with the vendor specific information through the platform so influence is greater through the platform.

The receiving block at 215 can thus comprise retrieving all or part of database 97, to be stored or linked within a respective account 96 (e.g. account 96-2) for later use in updating or modifying a room (e.g. room 104-2) corresponding to a respective data configuration 96 (e.g. data configuration 96-2). Functionality can be provided to permit browsing of database 97 from a client machine 86 to receive individual selections of one or more furnishings 108 for storage or linkage from a corresponding account 94. Other means for effecting block 215 are contemplated, in addition to, or in lieu of the approach described above. For example, in a variation, instructions as to which furnishing(s) 108 to place within a particular account 96 (e.g. account 96-2) can be invoked from another account 96 (e.g. account 96-1) that has been given permissions to do so. This variation contemplates a virtual “gifting”, or virtual “reward fulfillment” by placing of different furnishings 108 in one account 96 via instructions that are received from another account 96.

Block 220 comprises storing furnishing data in relation to room dimensions. The means by which such furnishing data is stored is not particularly limited, but generally contemplates storing data that can be used to render movable and rotatable images within the room dimensions at block 205. More specifically, block 220 contemplates that images, such as the views in FIG. 9, are scaled proportionately to the room dimensions defined at block 205. In one implementation, a plurality of raster images can be stored for one or more furnishings 108, as discussed further below, which show a particular furnishing from various angles. In another implementation, vectorized representations of for one or more furnishings are stored. Other implementations of block 220 will now occur to those skilled in the art.

Block 225 comprises receiving a furnishing or other asset selection. More specifically, block 225 contemplates receiving a furnishing or other asset selection, for subsequent placement within room 104 at block 230, and, as appropriate, orientation within room 104 at block 235. Accordingly, block 230 contemplates receiving a placement instruction of the furnishing selection within room 104, while block 235 contemplates receiving an orientation instruction for the selection within room 104.

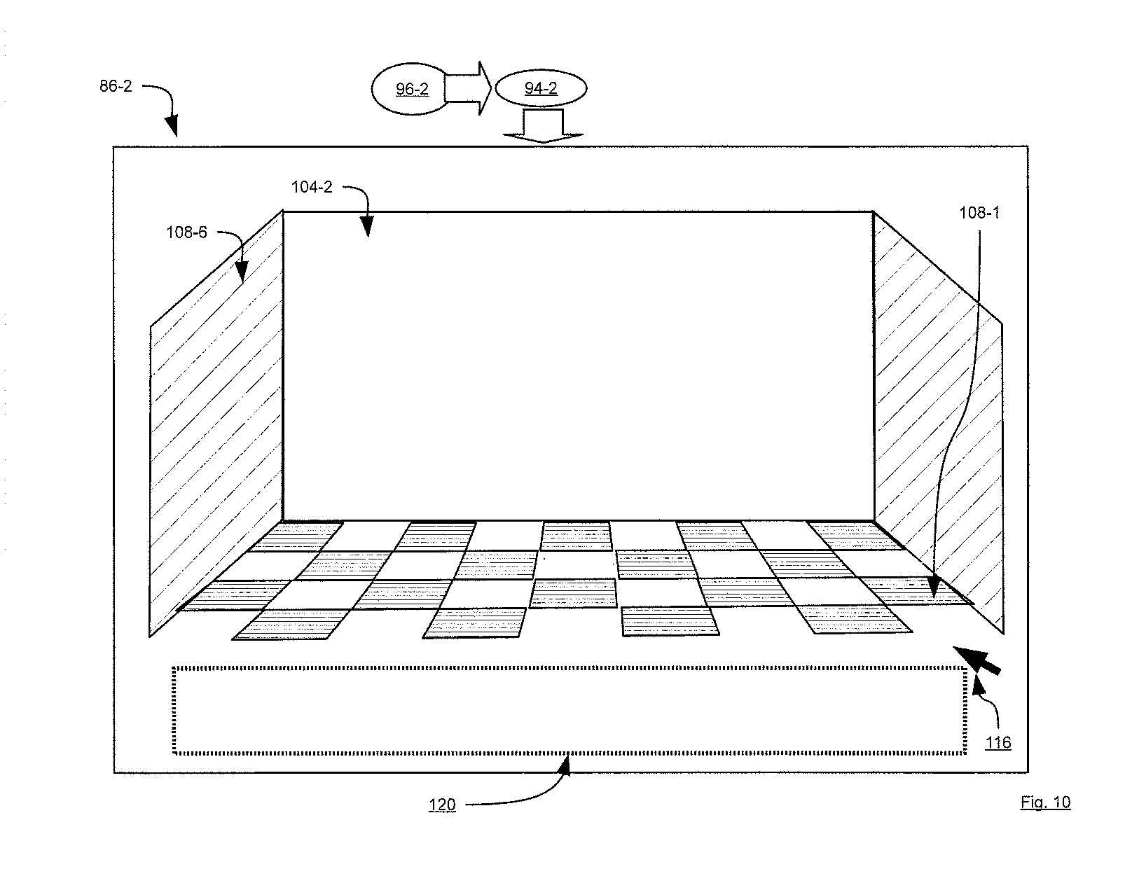

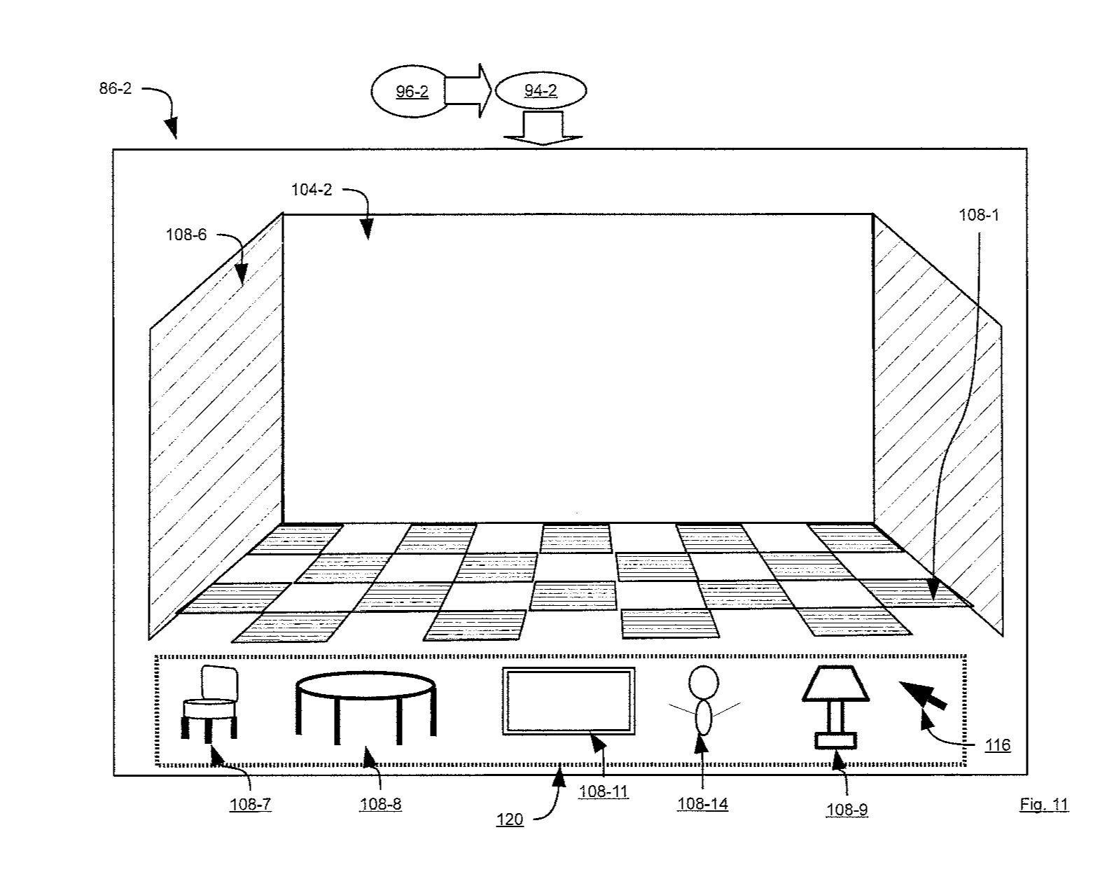

Block 225, block 230 and block 235 can be implemented various ways. Presently contemplated implementations of these blocks are illustrated by example in FIG. 10 and FIG. 11. In FIG. 10, room 104-2 is shown as having wall furnishing 108-6 (i.e. Pale Yellow Oil Paint from Henderson Paints) on each wall, and floor furnishing 108-1 (i.e. Checkered Linoleum Floor from ACME Flooring Co) on the floor area of room 104-2. The state of room 104-2 in FIG. 10 presumes block 225, block 230 and block 235 were already performed to virtually decorate room 104-2 from the state shown in FIG. 3.

Also note that FIG. 10 shows a cursor or pointer 116 and a tray region 120. The physical presence of pointer 116 may be expressly illustrated, or in the case of a touch screen then client machine 86 can be configured to define focus of a non-visible pointer 116 to be based on a physical gesture (e.g. the detection of a finger on a particular location of the display of client machine 86-2). The dotted line defining tray region 120 may be shown expressly or implicit, as desired). Transitioning from FIG. 10 to FIG. 11, it is contemplated that when cursor 116 (be it drawn expressly or be non-visible to simply reflect the detection of a finger depressing the touch screen within the area defined by tray region 120), then in FIG. 11 a sub-selection of possible furnishings 108 (which, as noted above, can have been previously selected from database 97) are shown which can be selected, placed and oriented within the virtual representation of room 104-2.

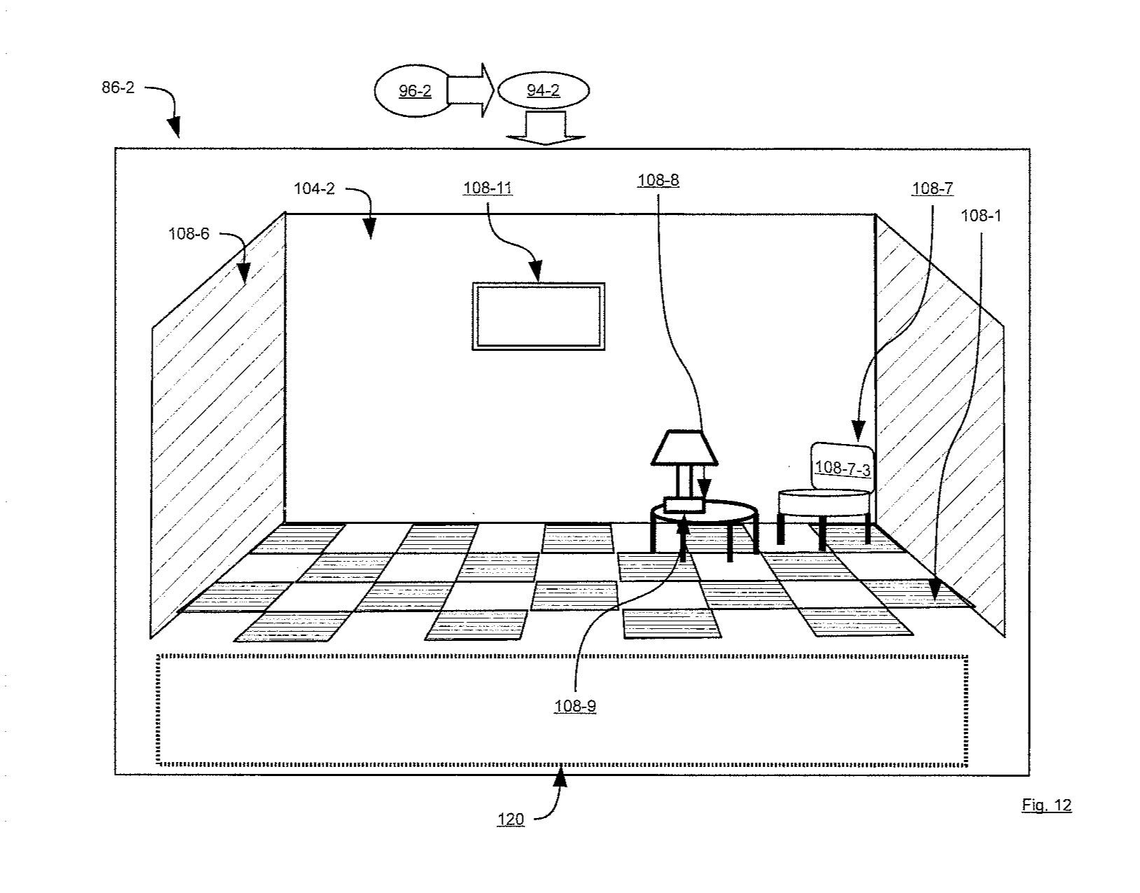

Transitioning from FIG. 11 to FIG. 12, it is contemplated that the various furnishings 108 shown in FIG. 11 have each been selected, placed and oriented within the virtual representation of room 104-2.

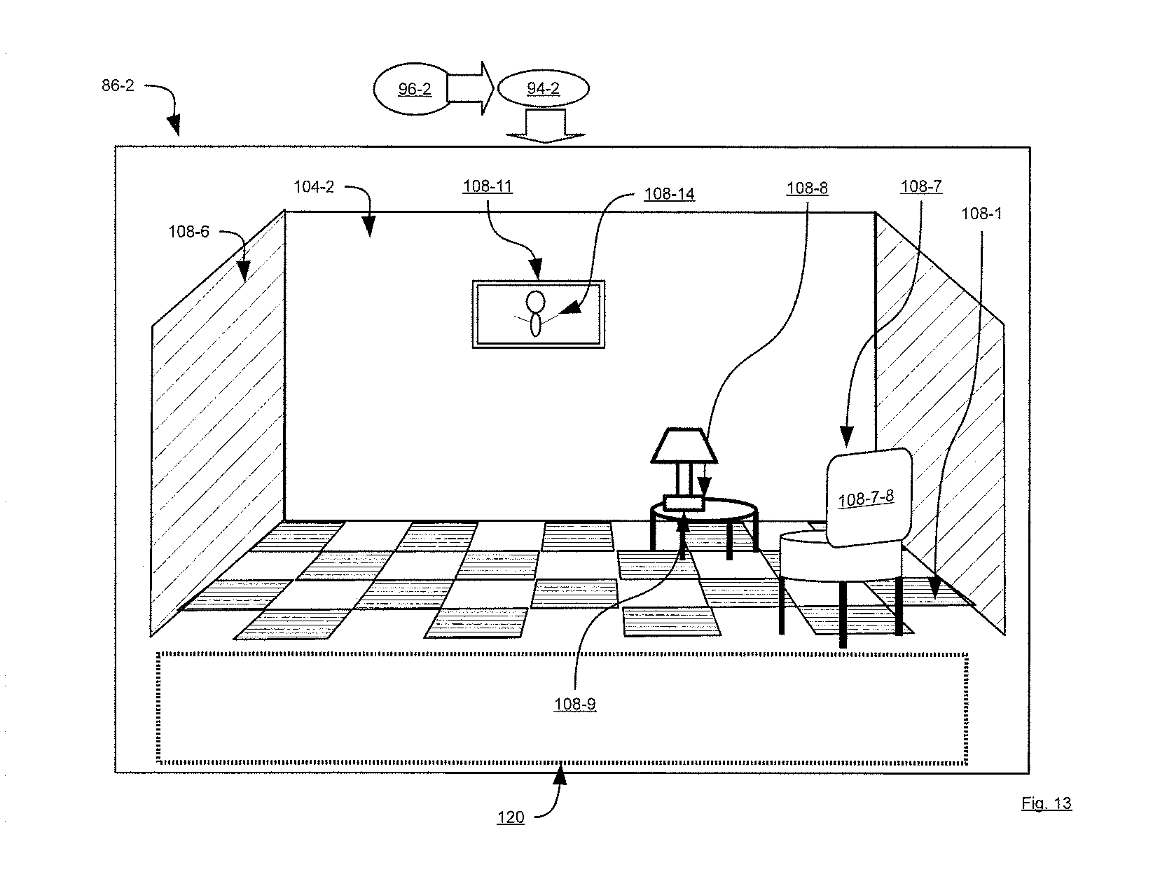

Note that in relation to orientation block 235, views, such as the views in FIG. 9, can be used to select a direction or orientation of a furnishing. Indeed, by way of example, transitioning from FIG. 12 to FIG. 13, in FIG. 12 it can be seen that view 108-7-3 was used to show the seat of the chair facing forward, and that view 108-7-3 was scaled smaller in size to show furnishing 108-7 at the back of room 104-2. However, in FIG. 13 it can be seen that view 108-7-3 was used to show the front seat of the chair to the view shown in FIG. 13, and that view 108-7-8 was scaled larger in size (relative to view 108-7-3) to show furnishing 108-7 at the front of room 104-2, and with the back of the chair furnishing 108-7 to the view shown in FIG. 13.

Referring now to block 240 of method 200 in FIG. 2, block 240 comprises rendering the furnishings within the room. The term rendering encompasses a wide variety of interactive functions that are logically tied to the “real-world” functionality of the various furnishings. For example, in FIG. 13, the movie “Perry-Hotter”, from movie furnishing 108-14 is shown as being virtually shown on television furnishing 108-11. By the same token, other interactive renderings are contemplated, such as being able to turn lamp furnishing 108-9 “on” or “off” and thereby animating the lighting effect from that lamp furnishing 108-9. Other interactive renderings can include playing song furnishing 108-15 from stereo furnishing 108-10 provided they were so selected and placed in room 104-2. Likewise, pausing, volume control, fast forwarding, media changing and other virtual controls of television furnishing 108-11, or stereo furnishing 108-10 are contemplated. Other interactive renderings can include, if provided, windows with changing daylight, and changing scenes outside the window and changes to lighting effect based on opening or closing of blinds, curtains or other window coverings. Other interactive renderings can include zooming in or zooming out, or virtually walking around room 104-2, or opening (if selected) book furnishing 108-13 for zooming in and reading as an e-book. Televisions can be zoomed in on to watch video full screen, art can be zoomed it on to view full screen on a branded television (showing the television frame) with a magnifying glass showing greater detail, and rugs can be zoomed in on to show a full screen top view. Again, a users network of friends (with user permission) will have the ability to visit the user's room and interact with their assets in various ways (again, based on user permission).

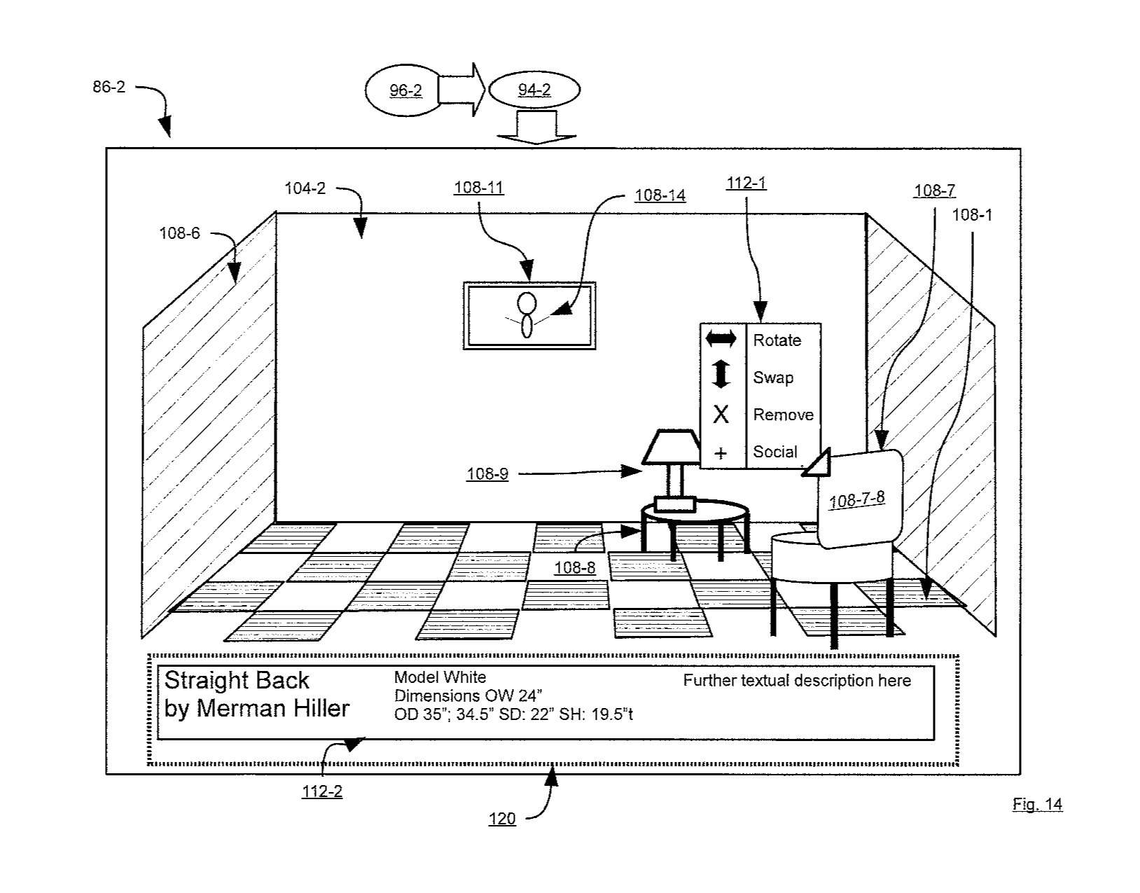

Variations, modifications and enhancements to method 200 are contemplated. One enhancement is shown in FIG. 14 in the form of one or more context windows 112. Such context windows 112 can be invoked when a particular furnishing 108 is selected or brought into focus. The means by which a furnishing is selected or brought into focus is not particularly limited. For example, where client machine 86 comprises a touch screen, then such selection can be effected by tapping or pressing on a particular furnishing 108. Where client machine 86 has a mouse, then a cursor may be used to point to or select a particular furnishing or other asset to move it by moving the mouse. Where client machine 86 has a keyboard, then keystrokes may be used to achieve a similar result. When an item is clicked on or selected, in addition to a menu, additional information about the item appears in the application window that includes but is not limited to the manufacturer name, catalogue # or SKU, dimensions of the item, price where applicable, a description of the item, and variation name (upholstery/finish option).

In FIG. 14, chair furnishing 108-7 has been brought into focus, and accordingly context windows 112 that are specific to chair furnishing are invoked. While FIG. 14 shows to specific examples of context windows 112, it is to be understood that such context windows are non-limiting examples. Context window 112-1 provides a menu context window with four choices: Rotate, Swap, Remove and Social. Selecting of Rotate from context window 112-2 leads method 200 back to block 235 where the furnishing orientation can be changed. Selecting Swap leads to a sub-menu (not shown) that allows the selection of different sub-options, in the forms colours or fabrics or other dependency options that are specific to chair furnishing 108-7. Selecting Swap therefore provides different sub-menu options depending on which furnishing 108 is selected. Selecting Remove deletes the selected furnishing 108 from the virtual room 104-2. Selecting Social invokes a plurality of potential social networking functions, the details of which will be discussed further below. Additional menu options in context window 112-1 can be provided, and some of those menu options may be specific to the particular selected furnishing 108. For example, in relation to lamp furnishing 108-9, context 112-1 can include the option to turn on, or off, or dim the virtual light emanating from the lamp furnishing 108-9. As another example, in relation to movie media furnishing 108-14, context 112-1 can include the option to turn play, stop, pause, cue backwards, cue forwards, adjust the volume, go to full-screen, the particular movie being shown. Context window 112-2 provides a complete description of the selected furnishing 108-7. In the non-limiting example shown, the name of the chair is shown and any other data that may be stored in relation to furnishing 108-7 in database 97. Further context windows 112 may be provided, and the exact contents and placement and means of invocation 112 can be varied and need not be implemented exactly as shown.

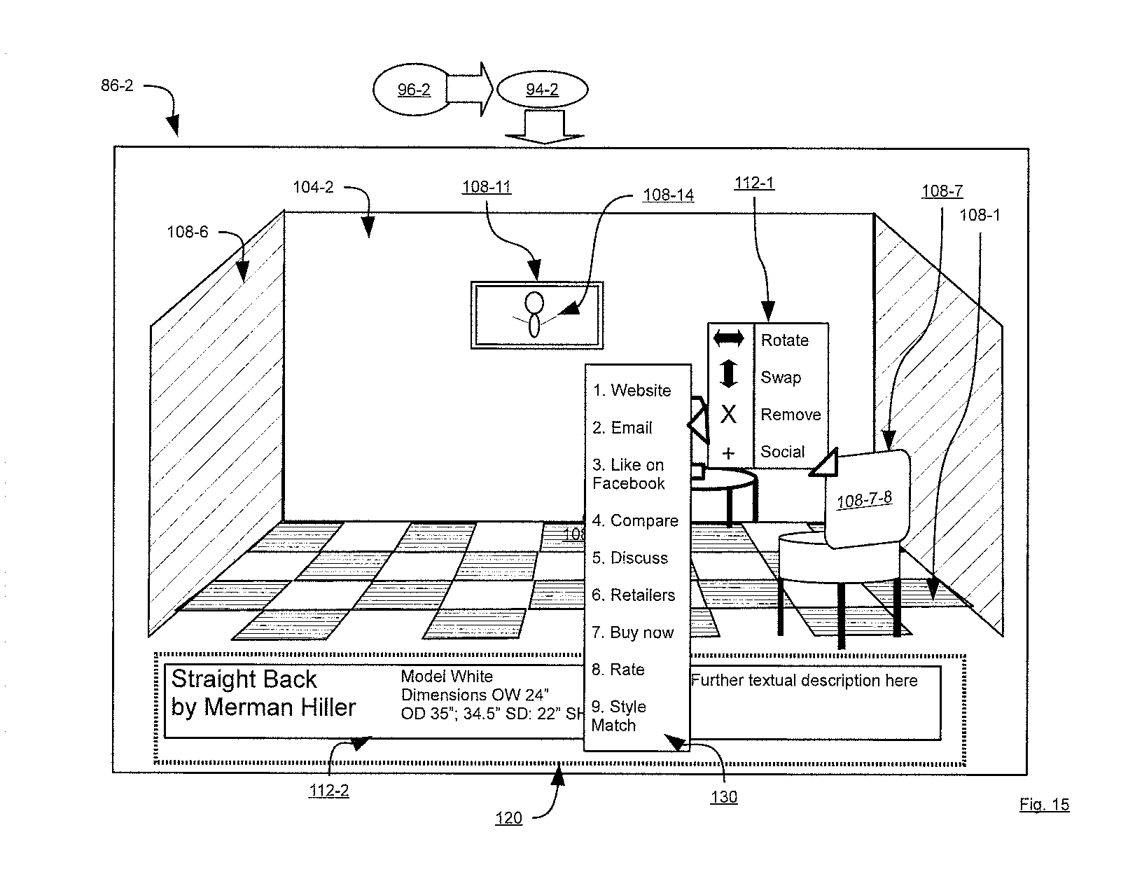

Referring now to FIG. 15, the selection of the “Social” menu item within context 112-1 will now be explained further. The selection of the “Social” menu item within context menu 112-1, or any of its sub-items is part of an enhancement to method 200. In general, the present specification contemplates that system 50 and its variants is the basis for a social networking platform. The teachings up to this point contemplate a technical structure upon which the social networking platform is based. FIG. 15 shows an example social networking menu 130 that includes a plurality of social networking functions. It is to be understood that the social networking functions in menu 130 are a non-exhaustive list: additional, fewer or different social networking functions can be included in menu 130. Furthermore, those social networking menu functions can even be different for different selections of different furnishings 108. However, menu 130 does show a presently contemplated list of menu functions, each of which will be discussed in greater detail below. These items may be made available when a user clicks on an item in the warehouse or after the item is placed in a room.

The “Website” sub-menu item on social networking menu 130 can be selected to open a web-page comprising additional data about the selected furnishing 108. The web-page can be locally hosted on central server 54, or can be hosted by an appropriate one of content servers 78. Where the web-page is hosted on a content server 78, then such a content server 78 can be hosted by, for example, a brand or manufacturer website, or by a retailer website that sells the selected furnishing 108. There may be two links for websites—one for the manufacturer and one for the retailer. Both incur a charge if clicked on. This feature drives brand engagement that otherwise would not have occurred.

The “Email” sub-menu item on social networking menu 130 can be selected to open a compose-email dialogue box within an email client application on the relevant client machine 86. The compose-email dialogue box would automatically include, by way or attachment or by embedding into the body of the email, data about the selected furnishing 108. The compose-email dialogue box would also accept any additional text and identification of addressee email addresses. This action also may incur a charge to the manufacturer. The user who has shared gains points for his action if it results in a successful impression on the receiving end.

The “Like” on social media platform sub-menu item on social networking menu 130 can be selected to invoke the “Like” function on a Facebook account (or another existing social network) entry that is associated with the selected furnishing 108. The social network account entry could be a Facebook account directly associated with the relevant account 94-2, or the Facebook account entry could be a Facebook account unique to the selected furnishing 108, or it could be a Facebook account entry hosted by a manufacturer or retailer of the selected furnishing 108. More generally, this sub-menu item contemplates any linkage to another social networking site whereby data associated with the selected furnishing 108 would be posted or otherwise attached to social network site account that is associated with either account 94-2 or with the selected furnishing or both. For example, a “Like on Facebook” sub-menu item could be replaced with, or supplemented by a “Tweet” sub-menu item whereby data about the selected furnishing 108 would be posted to a twitter account associated with account 94-2. Other social networking linkages that could be invoked from social networking menu 130 will now occur to those skilled in the art. Again, this drives brand engagement and provides a feedback loop to the brand showing who is engaging and what kind of community is being built around their product.

The “Compare” sub-menu item on social networking menu 130 can invoke one or more different comparison functions. One such function can be a price comparison function whereby a data listing of different retailers that sell the selected furnishing 108 is provided and generated on the display of client machine 86-2. Another such function can be an option comparison function whereby a data listing of different options are provided and generated on the display of client machine 86-2. For example, in relation to chair furnishing 108-7, such comparison can be between different colours, finishing and retailers that sell the selected furnishing 108. As another example, in relation to television furnishing 108-11, the “Compare” sub-menu item on social networking menu 130 can invoke comparison can be between different sizes and resolutions of related models to television furnishing 108-11, either from the same manufacturer or from different manufacturers.

The “Discuss” sub-menu item on social networking menu 130 can invoke a discussion or chat page hosted by central server 54 (or elsewhere on network 74) whereby ongoing chats, comments and textual threads as provided via different accounts 94 can be viewed, and also supplemented via the present account 94-2. This again provides a feedback loop with a direct pipeline telling the brand what people are saying about their product.

The “Retailers” sub-menu item on social networking menu 130 can invoke a page on display of client machine 86 listing the various brand owners or manufacturers or retailers that sell physical instances of the selected furnishing 108. Such a page can be similar to the retailer “Compare” features described above. The list of various brand owners or manufacturers or retailers may be automatically narrowed based on the location of client machine 86 or other location-based settings.

The “Buy Now” sub-menu item on social networking menu 130 can invoke a page on the display of client machine 86 leading a virtual checkout, whereby a financial account associated with account 94-2 is debited via financial service clearing infrastructure, which in turn remits funds to an entity or enterprise (e.g. an entity or enterprise that hosts a content server 78, or even the entity or enterprise that hosts central server 54 itself) that sells physical instances of the selected furnishing 108, such remitting satisfying funds necessary to transfer ownership in a physical instance of the selected furnishing 108 to the owner of the relevant account 94-2. The “Buy Now” function can also be associated with a function that arranges for shipping of the physical instance of the selected furnishing 108 to a physical address associated with the relevant account 94-2, or can be used to print a voucher at printer 95 which can be carried to a premises that stores the physical instance of the selected furnishing 108 and can be exchanged for that physical instance of the selected furnishing 108.

The “Rate” sub-menu item on social networking menu 130 can be used to receive data representing a numeric or other type of rating about the selected furnishing 108, which is then associated with both the account 94-2 as well as with the selected furnishing 108 within database 97. Such a rating would then be viewable via other accounts 94, as well as an aggregate or average rating can be calculated and stored in database 97 in relation to the selected furnishing 108.

The “Style Match” sub-menu item on social networking menu 130 can be used to invoke a tool that compares the selected furnishing 108 with all other furnishings 108, and provides a measurement or rating as to whether the selected furnishing 108 is considered a good match with the other furnishings 108. The algorithm used to determine the measurement is not particularly limited, and can, for example be based on scalar values such as colour. For example, different colours can be assigned different numbers. A “good” match score would be generated if the selected furnishing 108 had a colour number that generally matched the colour numbers of other selected furnishings 108. Another algorithm can be based on multi-dimensional criteria according to different subjective ratings, each corresponding to different general style classifications. Example colloquial names for such style classifications can include, “Modern”, “Contemporary”, “City”, “Country” and “Art Deco”. Each furnishing 108 within database 97 can then be assigned a number that indicates its match to that particular style classification. Each account 94, or account profile 90, can then in turn be associated with such a style classification. Invocation of the “style match” sub-menu item would then return a numeric or textual score indicating how close the selected furnishing 108 was to the style classification associated with the relevant account 94 or account profile 90.

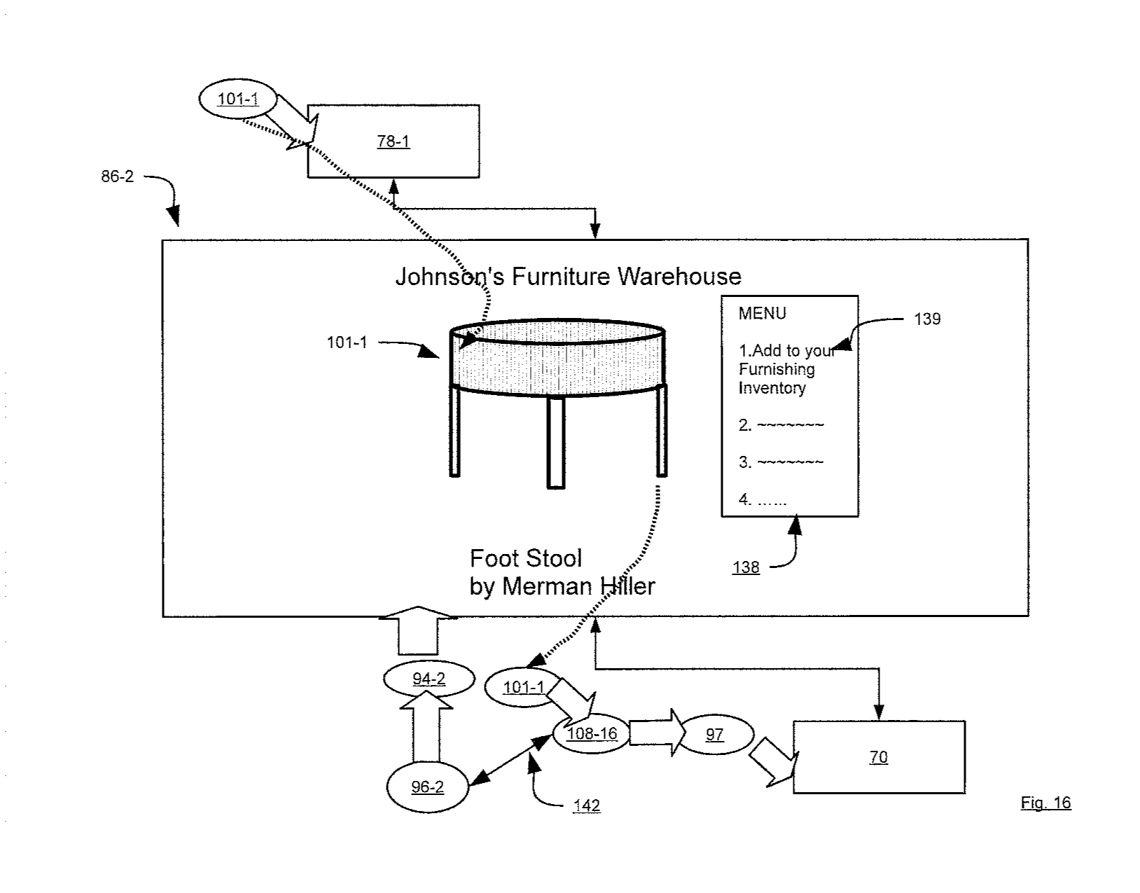

In another variation an import function of third-party furnishings 101 from one or more content servers 78 is provided. As noted above it is contemplated that content servers 78 currently host proprietary content including websites and the like that advertise, sell, rate or otherwise display third-party furniture 101. Such an import function contemplates an integration tool that can be accessed from a given client machine 86 that causes the importing (or linking) of a particular third-party furnishing 101 into database 97. The import function can be fully or partially automated whereby central server 54 crawls various content servers 78 to locate third party furnishings and then as possible, parses third party furnishings 101 and converts them to furnishings 108 and stores them in database 97. Where fields or images for a particular furnishing 108 cannot be automatically imported, then an exception handling routine can be invoked that prompts manual intervention to complete the entry the relevant fields in database 97. The import function can, in addition or in lieu of a crawling function, be invoked from a client machine 86. An example implementation of this implementation is shown in FIG. 16 whereby a website is shown hosted by content server 78-1. The website identifies the hosting entity as called “Johnson's furniture Warehouse” and is shown as a third-party furnishing 101-1 called “Foot Stool by Merman Hiller”. Client machine 86-2 in turn is shown also as generating a menu 138 that includes one or more options, one of those options being menu item 139 labeled “Add to your Furnishing inventory”. Receipt of instructions at client machine 86-2 corresponding to this menu item leads to third-party furnishing 101-1 being converted into furnishing 108-16 and in turn imported into database 97 for subsequent use in method 200 or its variations.

Note that the menu item 139 in menu 138 can be a purely locally hosted script or code on client machine 86-2, or it can be directly incorporated as a script into the original coding of the website hosted by content server 78-1 as a social media integration function that links directly to the social media platform hosted by central server 54. Again, where the import cannot be totally automated due to mismatch in database formatting at content server 78-1 and central database engine 70, then an exception can be generated to prompt manual intervention to complete the import via an interface hosted at central database engine 70. However, it is also contemplated that when a social media integration function that links a content server 78 directly to the social media platform hosted by central server 54, then such an integration function can include full automation of importing a third party furnishing 101 into database 97 as furnishing 108-16. Also according to the example in FIG. 16, a linkage 142 between furnishing 108-16 (i.e. the importation of third party furnishing 101) and the account 96-2 that is active when menu item 139 in menu 138 is invoked. Note that in variations, where third-party furnishing 101 is already imported into database 97, then only linkage 142 will result from selecting menu item 139.

A variation on the example of FIG. 16 contemplates a greater level of manual intervention, whereby any furnishings 101 that are stored on content servers 78 are manually reviewed or manually converted (e.g. format conversions, normalized image renderings (e.g. rasterizations or vectorizations), normalized field content populating) or both before actual storage as furnishings 108 in database 97.

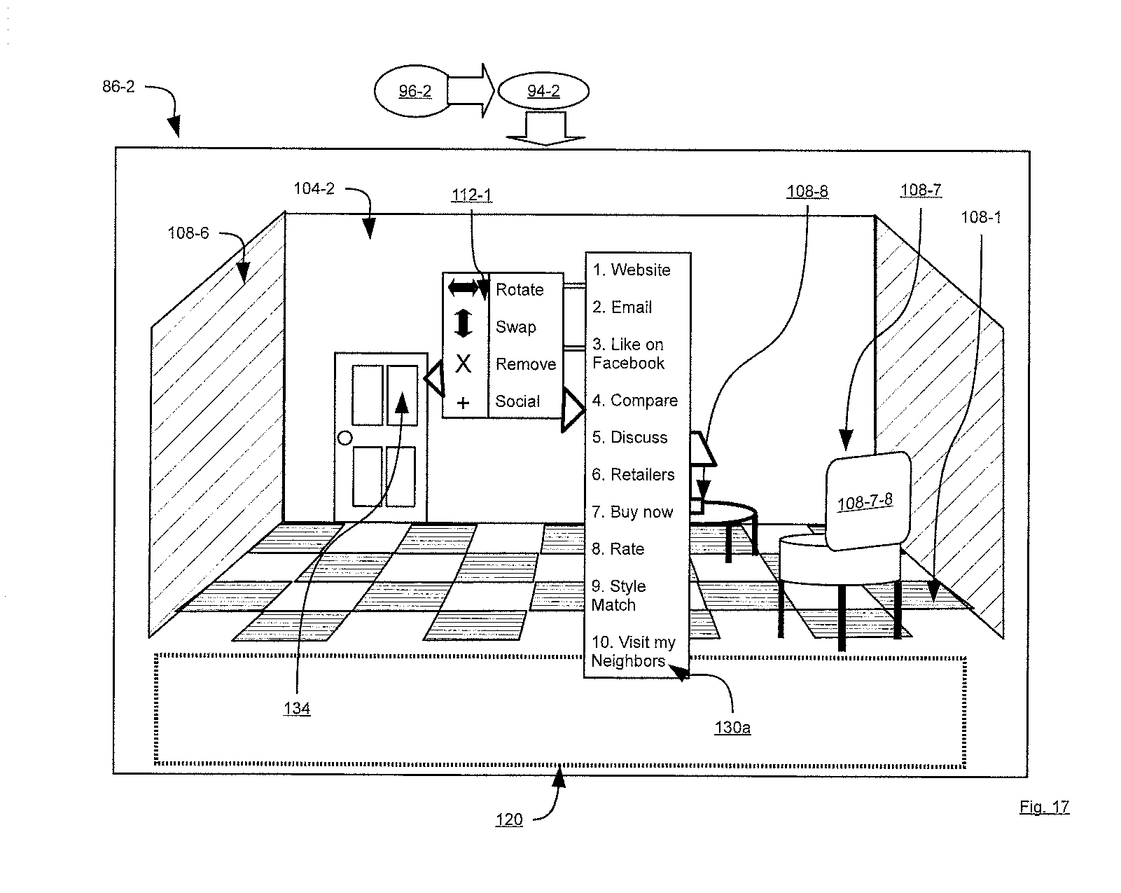

A still further variation is shown in FIG. 17 in the form of a representation door 134, which itself can be a unique type of furnishing 108 that can be stored in database 97 configured and interacted with according to method 200. Door 134 can also be configured with a special social networking menu 130a that includes an additional function labeled “Visit my neighbours”, referred to hereafter as neighbor networking function. By way of background, it is contemplated that a plurality of virtual rooms 104 may be created, at least one for each account 94. One or more accounts 94 may be linked as neighbors by way of an email invitation or other electronic means. Such linkages are then stored with each accounts 94. The neighbor networking function can thus be used to virtually exit door 134, and enter a room 104 of a neighbor account. For example, if account 94-1 is linked with account 94-2, then the neighbor network function could be used to exit virtual room 104-2 and enter virtual room 104-1 (not shown) associated with account 94-1. Typically, when account 94-2 is used to access virtual room 104-1, then menu 112-1 or menu 130 would include viewing functions or commenting functions, but not necessarily placement or orientation functions unless express permissions for same were granted. Doors may also be branded, leading to further engagement to manufacturers.

The present specification provides a new social network for creating, using and sharing personal unique online spaces populated with their favorite products. In certain implementations, the first web page is a Sign-up/Sign-in page. Here or once a user has signed up, a short video tutorial (e.g. approximately two minutes) can also be provided that explains how the social network works. Accounts are free. Upon account creation, a basic empty 3-D room is presented. Up to three views of the same room can be available, windowed (small & large), and full screen, all of which can be toggled between at any time using standard screen sizing icons. In some embodiments a room can consist of a back wall, a perspective wall on either side of the back wall, and a floor. Customization of room dimensions is also contemplated. Privacy and location settings configurations can also be provided, preferably shortly after signing up a new account. Various commercial partner entities that have content on servers 78 may provide financial incentives, and thus a reduced level of privacy setting can correlate to more financial incentives. Also, the more a user shares, the more they may be rewarded by the manufacturer or retailer. If a user buys something from a retailer or drives another user to a product that makes a sale, they could potentially receive a coupon or other ‘prize’ from the manufacturer.

Anything that increases brand engagement may be rewarded by brands and retailers. However, a skilled reader BUT, we have to be careful on how we reward. Rewards need to be random. A user cannot be promised a reward because that takes away the authenticity of their recommendation.

Another type of reward will be based on how much personal information a user shares. The more they share, the more they'll be rewarded. These rewards will come from Lootroom based on the affiliations we forge and what the user has expressed interest in. If they only provide us with the required information there is no reward, if they provide us with all the information asked of them there could possibly be a discount on all their purchases of virtual goods.

it is contemplated that a configured virtual room 104 will maintain its state after logging off the relevant account 94, and be available again upon re-accessing the account. Users may have several rooms active and saved at one time, with the user naming the rooms themselves. They can switch between these rooms at any time. Also, every time a user makes a change in their room (moves, rotates, adds or swaps and item) that change is automatically saved.

It is contemplated that a print function can be provided so a picture of the room can be generated on printer 95 in any state.

In certain implementations, an account holder is prompted to go to a virtual “Warehouse” (e.g. browsing a graphical rendering of database 97) to see the available furnishings or other assets 108 and then to select a subset of those for subsequent use. Alternatively a search of the entire database can always be available for furnishings 108.

It is contemplated that the majority if not all items in the database 97 are real-world items that have been rendered in three-dimensions so they can be positioned in any direction that makes sense for that item. Furnishings 108 are also preferably normalized in scale.

Database 97 can be searchable through a variety of indexes, including brand, by type of item (TVs, sofas, lamps, stereos, tables, etc.) and categorized by at least the following: Art, Cabinets, Carpets, Chairs, Decorations, Electronics, Lighting, Sofas, Tables, and Walls.

Central server 54 is configured to, in addition to generating search results, suggest similar models or items. Searching may also include style (art-deco, modern, classic, etc.) Another search may be by colour.

Each furnishing 108 is configured so that, when displayed, a pop-up or other dialogue box can be configured to appear with information on the furnishing including the brand name, the item name, dimensions, a description of the item and a “share” option.

The present specification contemplates a social networking function consistent throughout the application and can include one or more of the following options: 1) a link to the Brand or artist website, 2) an option to e-mail the item to a friend, 3) a link to compare the item with similar items, 4) an option to open or join a discussion about that item within the larger network, 5) and a link to local retailer information or website (depending on if the account holder has supplied his location in their account settings).

It is contemplated that accounts can be configured to accommodate multiple virtual rooms for each account.

To add furnishings from a list of previously selected items in the warehouse into a virtual room, a furnishing can be selected. If there are upholstery, finish, or other options available, a static pop-up will appear above the item and they will select the desired choice. To eliminate the popup, the account holder selects their choice or clicks off the menu. In one embodiment, once selected, the item appears at the front of the room with the rest of the room out of focus. The account holder will position the item in the room by clicking and dragging it and the rest of the room comes back into focus. Items that are meant to logically sit on a table require a table to first be placed in the room. The account holder then chooses the surface on which the item should sit. If there is no table in the room, a message appears stating, “There is no tabletop to place the item on”. Some items will have the option of placement on the floor or on a table.

Most items can be rotated and positioned within the room on a hidden grid system. The higher the number squares on the grid will make transitions smoother. When an item is in the room, each item is clickable. When the item is selected in the room, a pop-up will appear giving the account holder options unique to the type of item. Also, at this time, the item information such as brand name/item name/artist name, dimensions, and item description will appear directly under the room frame.

Furniture options can include: 1) Rotate right or left—using icons, 2) Swap—a drop-down menu appears for different finishes or upholstery if available, 3) Social—as described above, 4) Remove the item from the room. Items can include an “Add to Wishlist” menu option in the pop-up associated with that item. Much of the electronics can be virtually functional. Televisions will play what the Brand (ex. Sony, Samsung) wish to show. For example, Sony may wish to show movie trailers, advertisements, and for higher tiered account holders (account holders that share Sony products often, review products often and have their reviews carry weight, or buy Sony products through system 50 or its variants), full Sony movies. TV options include wall mounted or tabletop models. Wall mounted TV's can be moved anywhere on the walls, where tabletop models can only be placed on tables, but are allowed to rotate.

When an account holder clicks on a TV in their room they have the following options: 1) Zoom in—This enlarges the TV to full screen, so videos can be viewed larger while being played on the branded TV they have chosen. The room goes transparent white and the TV drops down from the top with the TV frame intact as if the were watching the actual TV. This way the brand and model remain visible, 2) Play—This drop-down menu shows all the available videos for each unique account holder, which the account holder may choose from by clicking on their selection, 3) Social.—This option displays a drop-down menu with the previously described social functions including web links to the manufacturer and local retailers, and 4) Remove the item from the room.

Currently, the app allows only one TV to be in the room at a time. In the future, we will consider allowing more than one TV to be in the rooms, but only one can play at a time.

Stereos will play music from the account holders specified playlists, or link to their choice of streaming music sites. How this will work specifically depends on the deals we can forge with companies like LastFM, Grooveshark, Apple and/or Spotify. It is also possible that account holders create their own playlists unique to their account 94. The stereos will produce the same pop-up as TV's except with audio files instead of video. Stereos will also be allowed to rotate. An opportunity for purchasing music arises when users visit a friend's room and likes music that friend has in their playlist. The friend may then purchase a track for play in their own playlist and becomes local to their own device.

TVs & Stereos will have standard controls for pause, play, stop, volume and sliders for current position.

A playlist can be a sub-menu from the play/stop menu item. Or, there can be a separate playlist menu item with the available video/audio titles in the sub-menu.

Music can be purchased directly from central server 54. Bands will be able to upload their own music for sale through an application process. Picture frames can be furnishings, (as in digital picture frames one can buy in the real world can function in the same way within the platform. Account holders can be able to upload their own personal pictures into these picture frames. These are meant to be seen, but will not be available in database 97 warehouse for other account holders to find. If the account holder has several pictures, the images can rotate at the account holders desired speed and settings.

Personal snapshots may also be uploaded into a photo album associated with an account. This can be configured to appear like any real world photo album the account holder creates from templates and can be stored on a shelf or table within that account holders room. Photo albums may be created same as one would create one at home in the traditional way. Images can be placed in the album in whatever sequence the user chooses and the experience of looking through the album will be almost as if it was tangible, where users can turn pages. The album can be placed on a shelf (or a table) where the user selects it and the album will come up full screen, and pages can be flipped through. Friends may comment in an unobtrusive way, and comments may be kept private or shared to whatever level the owner chooses.

A friend can be notified of new photos loaded into a friend's album or picture frame if allowed and desired. Albums will be animated as though a user is flipping through a real life album.

Bookshelves can be added to an account holder's room and their chosen books can sit on these shelves. Just as in the real world, a book may be removed and browsed through or read. We may work on an affiliation with Amazon, Indigo or similar enterprises for this. Shelves may be customized eventually and perhaps for a price.

Depending on the permissions an account holder sets, a friend can visit the account holder in their room to see what videos they have and listen to the music the account holder has in their playlist. Videos and music cannot be transferred from one account holder to another without a fee. Videos viewed in a friend's room cannot be enlarged to full screen.

Based on what is in the account holders library, the account holder can choose to be notified when a band they like is coming to town. This notification will have a direct link to purchase a ticket and will show up under the ‘News’ menu item. An extension of this (depending on Apple) is to sync the account holders iTunes library to the social networking platform. Again, an account holders friend can listen to the music within a friends room, but may not take it without paying a fee. Another possibility is to sync to a cloud based music site like LastFM or Grooveshark, or another desktop music application like Spotify.

Lamps can be functional with an on/off state. Eventually, the light will affect surrounding objects, but currently only the object itself will be affected. Lighting variations are also a possibility, where account holders could pick a “mood”.

Walls, also referred to as wall furnishings, can also be interchangeable and branded. Wallpaper and paint enterprises can provide wallpapers and paint colours to database 97. When the account holder clicks on the wall, a pop-up appears with the brand website, the colour and/or pattern name. Social options and a swap function can also be provided, though the rotate and placement functions are logically omitted. The account holder may purchase ‘premium’ wallpapers to place in their virtual room. This can be a revenue stream both for the content provider and for the operator of the present social networking platform. This technique can be extended to all types of furnishings 108.

Wall pop-ups can have sub groups separating paint, wallpaper and colour options. Walls may be selected separately or together.

A person skilled in the art will realize that various aspects of the platform may be enhanced using gamification. For example, registered users may be given a certain amount of virtual currency upon signing up, and then rewarded for increased interaction within the application in the form of that currency. They can then spend that currency on premium products that enhance the virtual experience, such as for example plants, views from windows, decorative features like fireplaces, etc.

Wallpaper and paint brands can have a certain amount of patterns and colours available at no-charge. Additional papers and colours will have a fee if the account holder intends to place them in their virtual rooms 104. The free offerings still give good brand exposure, but are limited so the account holder may want to increase their choices by paying. This feature can be extended to all types of furnishings 108.

A magnifying glass can be available for wallpaper, or other furnishings such as artwork and rugs. If the option is chosen, account holders can mouse over (or in the future hover, touch) the area they'd like enlarged for a closer look.

Floor furnishings can also be interchangeable. Further examples of floor furnishings include white, oak, teak, ebony, concrete, Royal red Carpet, black & white checkered and some fun options Sand, Grass, Sky, and Water. We will add additional wood and carpet options. Floor options can also be branded with a no-fee and premium structure as in the wall furnishings.

Artworks are another type of contemplated furnishing 108. When a piece of art is selected from database 97, it can be be placed in virtual rooms 104 as described above. Framing can also be an option.

Central server 54 can also be configured to handle digital rights management for songs, books, videos and artwork, including restricting dissemination of copies and licensing sales. All artwork remains subject to copyright of the artist and artist credit is displayed in the information. Information on where to buy the art will also be highlighted as will any additional information the artist would like to add, such as date, edition, dimensions, link to artist site, etc.

In this manner, artists may also utilize central server 54 and database 97 as a virtual gallery, showcasing all their work in their own room, which they can set as accessible to all.

Users may also upload completed rooms to galleries, either specific to them and shared with their friends as specified in their preferences or to a greater public gallery. This further drives brand engagement as this increases the opportunity for product to be viewed and shared.

Brands and manufacturers may also create their own rooms (galleries) with only their product. This is a way to showcase their product as if it were on the showroom floor with context and ideas that will provide users inspiration to create their own spaces. The analytics gathered here will be the same as if users were going directly to brand websites with the added benefit of gaining insight into who the user is. Users will be able to take items directly from the brands' rooms and add it to their own rooms.

Artists may have virtual galleries with only their art, or in collaboration with other artists. The platform enables measurement of who is visiting their room and what items users are interested in. We can measure level of interest with a click on an item or a more engaged user would take the item and place it in their own room. Further to that, we can measure how that users friends are engaging with the item after it's placed in their friends room.

System 50 can be configured so that once a piece of art is placed in a virtual room 104, the account holder can click (or double-click) on that piece and a pop-up will appear with the standard social functions, the remove function, an option to Swap the frame if available, and as in the TV 108-11, the account holder can zoom in (enlarge) on the art. When Zoom in is clicked on everything else on screen disappears and the art drops in full screen for detail. In addition, a magnifier will show even more detail when in full screen mode.

An account holder may select a furnishing 108 directly from their friends' or neighbour's virtual room. This can be reported as a specific analytic to the brand originator (e.g. an operator of content server 78) of the furnishing 108 and cause an update to a corresponding profile 90. The brand originator can have the option to use the profile and send an electronic coupon relating to that item in the real world.

As discussed above in relation to FIG. 16, an import feature can be provided. As a variation, a form can be completed requesting that a furnishing be added to database 97 via a central server 54 interface.

Rewards and promotions can be recorded in a profile 90 based on selections and other interactions with a particular furnishing 108, or if a furnishing 108 is or shared it with a friend account. Additional interaction can include signing up for newsletters from a brand originator of a particular furnishing 108, or promoting/referring products to other account holders.

The rewards can be determined through the development of an aggregation strategy with the brand and it's affiliate networks and distribution channels, and could include coupons, notification of regional product sales, prizes (a chance to win the real world product), etc.

Accounts 94 can be provided with increased capabilities (as in other virtual world or massively multiplayer online role playing games) and earn more prizes for increased interaction (such as the weight of their reviews, recommendations, sharing items, etc.)

The navigation bar at the top of a display generated on a client machine 86 can include a personal greeting, an option to view database 97, a drop-down menu of all the virtual rooms attached to an account, a list of the associated accounts (i.e. “friends” or “neighbours”), a wish list, rewards, mail, news, account settings, a help function and a search function.

Account holders can have the option to save rooms and start again from scratch.

Account holders may select to have a bedroom, living room and office for example. A list of all saved rooms named by the account holder will appear from a drop-down menu in the nav bar.

A door can be a portal in room, which an account holder can go through to enter another one of their rooms or a specified friends room. When the door is clicked on, it can be configured to open and a list of the account holders rooms and/or a list of friends appears who have allowed you to visit.

If an account holder chooses, they may allow anyone to enter their room, or may choose to allow only certain friends or neighbours to enter.

Account holders can also leave a note behind in someone else's room, which would be visible to all who enter. The account holder can then delete the note or store it for others to comment as well. There will be an icon for stored notes at the top of the room. When the icon is clicked on, a list would appear in a white semitransparent box on top of the room with fields in which account holders can add comments or new notes.

Each account holder can have a list of their ‘Friends’ or people they share their information with outside of Brands. Here, account holders can find a particular friend and choose to visit that friends' room. They can also leave a public note for that friend from this menu as well as from within that friends room using the icon.

Account holders can also have a ‘Wish List’, listing the items they'd like to buy in the real world. Ideally we would like to have a piggy bank function where account holders can save toward purchasing that item, but becoming a bank may have even greater barriers than creating a novel social network.

Also in the navigation bar, is a drop-down of the account holders available Rewards. If a brand has offered a coupon towards a real world purchase it would appear here. What is offered depends on each brand individually.

The ‘Mail’ option is a private messaging function. Here, friends can send a private message to another friend, or a brand can send a newsletter or other correspondence, depending on how much the account holder allows.

A ‘News’ option can be provided including news involving friend account holder's activity. E.g. if “Bob” (account holder one) purchases a new LG TV in real life and reviews it in his virtual room (or other context of his account), then his friend “Sandy” (account holder two that is linked to account holder one) will receive electronic notification about that review in account holder two's virtual room, or within other contexts of account holder two's account. Who bought/placed what, friends visiting other friends' rooms, and discussions between friends on brands or items all fall under ‘News’. Also, as mentioned account holders may be notified of their favorite band coming to town, a new movie or trailer available, etc.

A news feed can also be configured to notify account holders of new items added to database 97.

System 50 can be modified to include a game play like features, where account holders can gain additional “reward points” (e.g. a numerical setting in an account holder's profile 90) for increased and ongoing interaction with their rooms. Such points may be redeemable for coupons or real world instances of furnishings 108 or other articles or services.

For example, regular visitation, signing up friends, posting commentary on product, visiting friends' rooms, etc. Increased standing will also earn reward points offered by central server 54 directly and can include incentives to continue interacting, coupons or gift cards toward favorite brands, etc.

Account holders can also be configured to download YouTube videos to their TV's. YouTube videos and all other public domain videos may go full screen. The platform may also be linked to Netflix.

In the posted gallery rooms, people can comment on items, review items, generate a list of items, and take items for their own rooms.

Accounts 90 can be corporate or enterprise accounts, hosted and maintained by for example Home Depot, Ikea, West Elm, Crate & Barrel, etc. may all have public rooms to display decorating hints and ideas.

Such enterprises may offer terminals in their own physical premises which can be used as client machines 86.

System 50 can be a stand-alone social network or can be an application could even be embedded within another website, blog or within another social networking site such as Facebook or Google+, or within an e-commerce site such as Amazon or E-Bay. Or there can be networking interconnections between each.

System 50 may be used as a gift registry. A couple having a baby might want to set up a virtual nursery room to show desired furnishings that could be received as physical gifts, then items are purchased through access to the virtual nursery room by neighbor accounts, that furnishing 108 would show as bought and no longer an option. Details on who bought it may also be shared. When a gift registry is activated, an affiliate program is enabled where the creator of the registry receives compensation for every furnishing sold through system 50.

In variations, an avatar can also be provided as designed by the account holder which can virtually habit the virtual room. The avatar can be configured can “walk” around their rooms, interact with the furnishings items in the room as well as with other account holders. In these variations, clothing can be another type of furnishing 108. These virtual people will also be able to have conversations through the account holders own voices.

Virtual pets are also contemplated. Moving, purring, barking pets with names and personalities that can be interacted with. A friend can buy you a pet if they choose.

As noted a fish tanks can also be a furnishing 108. Account holders can customize their tanks with plants and ornaments and select any types of fish based on whether the tank is freshwater or saltwater. Fish will swim and be reactive to a mouse or touch. As you mouse over, fish will turn to look at you. Fish tanks may also be enlarged to full screen.

Note that not every furnishing 108 need necessarily have a real world analogue in database 97, but may exist in virtual form only.

Financial service clearing infrastructure 82 can also be configured to accommodate credit cards or other financial facilities issued by the operator of central server 54.

It is contemplated that data representations of furnishings 108 can be provided in physical premises as OR codes (or other near field communication (NFC) technique), which are displayed by the physical instance of such furnishings 108. It is contemplated that an import (as a variation on the import discussed in relation to FIG. 16) the furnishing 108 to their account 94 by scanning the NFC code using a mobile computing device such as an iPhone equipped with a camera and an application that can perform the import.

Central server 54 can be configured to charge account fees for functional items.

Account holders can also be encouraged to access their accounts 94 through a lottery, couponing, a chance to win a virtual premium product, buy a ticket to win an item in the real world.

Various other features may be added to the platform. For example, the platform may be linked to a holographic suite to enable the experience of rooms on a scale similar to those that would present with the physical objects. The platform may utilize design contests, which may be sponsored, through the platform, The platform may also include 360 degree views of products in QUICK TIME for example. Clocks in rooms may be presented as functional clocks. A paint tool may be provided to pain walls in colour. The platform may enable users to upload their own scenes for outside their windows. Different augmented reality technologies may be used such as haptics. Haptics would allow users to touch and feel textures like different upholsteries.

Accounts 94 can be configured to be accessible with a single-sign on such as Open ID, to permit provision of credentials in using a Facebook, Twitter, Google or Pinterest account holder ID.

While the foregoing provides certain non-limiting example embodiments, it should be understood that combinations, subsets, and variations of the foregoing are contemplated.

1. A social media platform comprising at least one server configured to:
receive room data representing three-dimensions of a room;
render an image of said room using said dimensions on a display of a client machine connected to said server;
receive furnishing data representing a furnishing inventory;
store said furnishing data scaled in relation to said dimensions;
receive a furnishing selection from said stored furnishing data;
receive furnishing placement instructions for positioning said furnishing selection within said image of said room;
render an image of said furnishing within said image of said room based on said placement.

2. The social media platform of claim 1 wherein a unique account is associated with said image of said furnishing within said image of said room.

3. The social media platform of claim 1 or claim 2 wherein said furnishing data comprises a plurality of furnishings and wherein said furnishings are associated with at least two different content servers connectable to said at least one server.

4. The social media platform of any one of claims 2-3 wherein a second unique account is associated with a second image of a second room.

5. The social media platform of claim 4 wherein said second unique account is associated with said first unique account such that said second unique account is configured to access said first unique account.

6. The social media platform of claim 4 wherein said access comprises one or more of viewing said image of said furnishing within image of said room and supplementing furnishing data within said inventory.

7. The social media platform of any one of claims 1-6 wherein said server is further configured to receive furnishing rotation instructions in addition to said furnishing placement instructions.

8. The social media platform of any one of claims 7 wherein said furnishing data comprises a plurality of raster images for at least one said furnishings; each of said raster images corresponding to a different view from a different angle of said furnishing used for rendering said furniture according to said furnishing rotation instructions.

9. The social media platform of any one of claims 1-8 wherein said server is further configured to receive additional furnishing selection and additional furnishing placement instructions.

10. The social media platform of any one of claims 1-9 wherein said server is further configured to receive and process at least one social networking interaction in association with at least one furnishing.

11. The social media platform of any one of claims 1-10 wherein said at least one social networking interaction comprises a link to a web site; an email invocation attaching a data descriptor of said at least one furnishing; a link to another social media platform; a link to a discussion platform; a link to a financial transaction to purchase or compare said at least one furnishing; a link to a style matching engine; a link to a retailer or a manufacturer of said at least one furnishing; a link to a discussion forum about said at least one furnishing.

12. The social media platform of any one of claims 1-11 wherein said furnishing inventory comprises one or more of wall coverings, floorings, chairs, tables, chesterfields, art work, media, media players and doors.

13. The social media platform of claim 12 wherein media comprises one or more of books, music and videos and wherein media players comprise one or more of e-readers, music players, stereos, and televisions.
